(19) United States
(12) Patent Application Publication
(10) Pub. No.: US 2024/0345461 A1
(43) Pub. Date: Oct. 17, 2024

(54) INFORMATION PROCESSING APPARATUS, INFORMATION PROCESSING METHOD, AND INFORMATION PROCESSING PROGRAM

(71) Applicant: FUJIFILM Corporation, Tokyo (JP)

(72) Inventors: Toshihiro Ooguni, Saitama-shi (JP); Kenshi IMAMURA, Saitama-shi (JP); Toshiaki NAGAI, Saitama-shi (JP)

(73) Assignee: FUJIFILM Corporation, Tokyo (JP)

(21) Appl. No.: 18/756,264

(22) Filed: Jun. 27, 2024

Related U.S. Application Data
(63) Continuation of application No. PCT/JP2022/046492, filed on Dec. 16, 2022.

(30) Foreign Application Priority Data
Dec. 28, 2021 (JP) 2021-214489

(51) Int. Cl. G03B 21/14; G06T 3/40; G06T 3/60; H04N 5/74

(52) U.S. Cl. CPC G03B 21/142; G06T 3/40; G06T 3/60; H04N 5/74

(57) ABSTRACT

An information processing apparatus includes a processor, and the processor is configured to: acquire first image data representing a first image obtained by imaging with an imaging device; acquire disposition data related to a disposition of a virtual projection surface and a virtual projection apparatus in a space indicated by the first image; acquire disposition change data related to a disposition change of at least one of the virtual projection surface or the virtual projection apparatus in the first image; generate second image data representing a second image in which at least one of the virtual projection surface or the virtual projection apparatus of which the disposition is changed based on the disposition change data is displayed on the first image; and output the second image data to an output destination.

### CROSS REFERENCE TO RELATED APPLICATION

This is a continuation of International Application No. PCT/JP2022/046492 filed on Dec. 16, 2022, and claims priority from Japanese Patent Application No. 2021-214489 filed on Dec. 28, 2021, the entire disclosures of which are incorporated herein by reference.

### BACKGROUND OF THE INVENTION

### 1. Field of the Invention

The present invention relates to an information processing apparatus, an information processing method, and a computer readable medium storing an information processing program.

### 2. Description of the Related Art

JP2005-311744A discloses a projection type display device that displays an optimal installation position with respect to a screen to a user in an easy-to-understand manner to guide the user. In the projection type display device, a camera images a projection direction thereof, and a screen determination unit detects a projection range of the screen based on an imaging result of the camera and determines relative position information of the projection type display device with respect to the screen. In addition, an installation location guide unit performs guidance such that the projection type display device can be installed in a position at which a projection image can be projected onto a projection surface of the screen based on the position information determined by the screen determination unit. The installation location guide unit is configured by using, for example, a plurality of LEDs and a plurality of directional keys, and displays a current installation position of the projection type display device in a visually recognizable manner based on the installation position information determined by the screen determination unit. Then, the user can easily perform position setting of the projection type display device while viewing the display.

JP2011-060254A provides an augmented reality system that displays a virtual object input by a user. The augmented reality system acquires information related to a position and a direction of an augmented reality device in a case where the user inputs the virtual object, and records the acquired information related to the position and the direction together with information related to the virtual object. In a case where the user uses the augmented reality system, in a case where the user approaches the input position and direction related to the virtual object, the virtual object input by the user is displayed in a state of being superimposed on a real environment.

### SUMMARY OF THE INVENTION

One embodiment according to a technology of the present disclosure provides an information processing apparatus, an information processing method, and a computer readable medium storing an information processing program with which it is possible to improve a user's convenience related to a disposition change of a virtual projection surface and/or a virtual projection apparatus.

An information processing apparatus according to an aspect of the present invention is an information processing apparatus comprising a processor, in which the processor is configured to: acquire first image data representing a first image obtained by imaging with an imaging device; acquire disposition data related to a disposition of a virtual projection surface and a virtual projection apparatus in a space indicated by the first image; acquire disposition change data related to a disposition change of the virtual projection surface and/or the virtual projection apparatus in the first image; generate second image data representing a second image in which the virtual projection surface and/or the virtual projection apparatus of which the disposition is changed based on the disposition change data is displayed on the first image; and output the second image data to an output destination.

An information processing method according to another aspect of the present invention is an information processing method using an information processing apparatus, in which a processor of the information processing apparatus is configured to: acquire first image data representing a first image obtained by imaging with an imaging device; acquire disposition data related to a disposition of a virtual projection surface and a virtual projection apparatus in a space indicated by the first image; acquire disposition change data related to a disposition change of the virtual projection surface and/or the virtual projection apparatus in the first image; generate second image data representing a second image in which the virtual projection surface and/or the virtual projection apparatus of which the disposition is changed based on the disposition change data is displayed on the first image; and output the second image data to an output destination.

An information processing program stored in a computer readable medium according to still another aspect of the present invention is an information processing program of an information processing apparatus, the information processing program causing a processor of the information processing apparatus to execute a process comprising: acquiring first image data representing a first image obtained by imaging with an imaging device; acquiring disposition data related to a disposition of a virtual projection surface and a virtual projection apparatus in a space indicated by the first image; acquiring disposition change data related to a disposition change of the virtual projection surface and/or the virtual projection apparatus in the first image; generating second image data representing a second image in which the virtual projection surface and/or the virtual projection apparatus of which the disposition is changed based on the disposition change data is displayed on the first image; and outputting the second image data to an output destination.

According to the present invention, it is possible to provide the information processing apparatus, the information processing method, and the computer readable medium storing the information processing program with which it is possible to improve the user's convenience related to the disposition change of the virtual projection surface and/or the virtual projection apparatus.

### BRIEF DESCRIPTION OF THE DRAWINGS

FIG. 1 is a schematic diagram showing a schematic configuration of a projection apparatus 10 as an installation support target of an information processing apparatus according to an embodiment.

FIG. 2 is a schematic diagram showing an example of an internal configuration of a projection portion 1 shown in FIG. 1.

FIG. 3 is a schematic diagram showing an exterior configuration of the projection apparatus 10.

FIG. 4 is a schematic cross-sectional view of an optical unit 106 of the projection apparatus 10 shown in FIG. 3.

FIG. 5 is a diagram showing an example of an information processing apparatus 50 according to the embodiment.

FIG. 6 is a diagram showing an example of a hardware configuration of the information processing apparatus 50 according to the embodiment.

FIG. 7 is a diagram illustrating a projection apparatus coordinate system CA that is an example of a coordinate system of a virtual projection apparatus 202.

FIG. 8 is another diagram illustrating the projection apparatus coordinate system CA that is an example of the coordinate system of the virtual projection apparatus 202.

FIG. 9 is a diagram illustrating a projection surface coordinate system CB that is an example of a coordinate system of a virtual projection surface 204.

FIG. 10 is a flowchart showing an example of processing performed by the information processing apparatus 50 according to the embodiment.

FIG. 11 is an example of an operation image displayed by a tablet that is the information processing apparatus 50 according to the embodiment.

FIGS. 12A and 12B are other examples of the operation image displayed by a smartphone that is the information processing apparatus 50 according to the embodiment.

FIGS. 13A and 13B are other examples of the operation image mainly based on a touch operation, which is displayed by the information processing apparatus 50 according to the embodiment.

FIG. 14 is a diagram showing an operation of horizontally moving the virtual projection apparatus 202 in the operation image of FIG. 13A.

FIG. 15 is a diagram showing an operation of moving the virtual projection apparatus 202 up and down in the operation image of FIG. 13A.

FIG. 16 is a diagram showing an operation of rotating the virtual projection apparatus 202 in the operation image of FIG. 13A.

FIG. 17 is a diagram showing an operation of rotating the virtual projection surface 204 in the operation image of FIG. 13B.

FIG. 18 is a simulation diagram of an initial state in a virtual projection apparatus priority mode in the coordinate system of FIG. 7.

FIG. 19 is a diagram illustrating movement of the virtual projection apparatus 202 in a left direction in FIG. 18.

FIG. 20 is a diagram illustrating movement of the virtual projection apparatus 202 in a rear direction in FIG. 18.

FIG. 21 is a diagram illustrating movement of the virtual projection apparatus 202 in an upward direction in FIG. 18.

FIG. 22 is a simulation diagram of an initial state in a virtual projection apparatus priority mode in the coordinate system of FIG. 8.

FIG. 23 is a simulation diagram of an initial state in a virtual projection apparatus priority mode in the coordinate system of FIG. 9.

FIG. 24 is a diagram illustrating movement of the virtual projection surface 204 in a right direction in FIG. 23.

FIGS. 25A to 25C are diagrams illustrating a state of a projection apparatus installation virtual surface 201 and a spatial coordinate system CC.

FIG. 26 is a diagram of an image showing a state displayed on a touch panel 51, in which the virtual projection apparatus 202 is installed on a floor surface.

FIG. 27 is a diagram showing a state displayed on the touch panel 51, in which the virtual projection apparatus 202 is suspended from a ceiling surface.

FIG. 28 is a diagram showing a state in which a shift range F1 is displayed in the virtual projection apparatus priority mode.

FIG. 29 is a diagram showing a state in which a position of the virtual projection apparatus 202 or the virtual projection surface 204 is clipped by the shift range F1 at an end of a lens shift range to restrict movement beyond the range, in FIG. 28.

FIG. 30 is a simulation diagram of an initial state in a case where the position of the virtual projection apparatus 202 is not fixed in a virtual projection surface priority mode.

FIG. 31 is a diagram illustrating movement of the virtual projection surface 204 in the left direction in FIG. 30.

FIG. 32 is a simulation diagram of an initial state in a case where the position of the virtual projection apparatus 202 is fixed in the virtual projection surface priority mode.

FIG. 33 is a diagram illustrating movement of the virtual projection surface 204 in the left direction in FIG. 32.

FIG. 34 is a simulation diagram of an initial state in a case where the position of the virtual projection apparatus 202 is not fixed in the virtual projection surface priority mode.

FIG. 35 is a diagram illustrating enlargement of the virtual projection surface 204 in FIG. 34.

FIG. 36 is a simulation diagram of an initial state in a case where the position of the virtual projection apparatus 202 is fixed in the virtual projection surface priority mode.

FIG. 37 is a diagram illustrating enlargement of the virtual projection surface 204 in FIG. 36.

FIG. 38 is a diagram showing an example of a method of displaying a boundary of a space through which projection light passes.

FIG. 39 is a diagram showing another example of the method of displaying the boundary of the space through which the projection light passes.

FIG. 40 is a diagram showing a first step of installation assist.

FIG. 41 is a diagram showing a second step of the installation assist.

FIG. 42 is a diagram showing a third step of the installation assist.

### DESCRIPTION OF THE PREFERRED EMBODIMENTS

Hereinafter, an example of an embodiment of the present invention will be described with reference to the drawings.

### <Schematic Configuration of Projection Apparatus 10 as Disposition Change Target of Information Processing Apparatus 50 According to Embodiment>

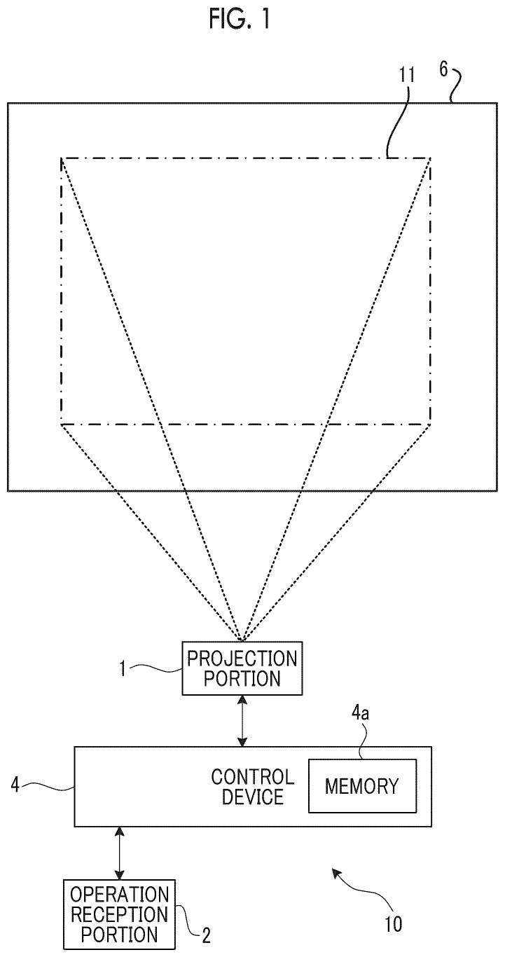

FIG. 1 is a schematic diagram showing a schematic configuration of a projection apparatus 10 as an installation support target of an information processing apparatus according to the embodiment.

The information processing apparatus according to the embodiment can be used, for example, for supporting a disposition of the projection apparatus 10. The projection apparatus 10 comprises, for example, a projection portion 1, a control device 4, and an operation reception portion 2. The projection portion 1 is composed of, for example, a liquid crystal projector or a projector using liquid crystal on silicon (LCOS). Hereinafter, the projection portion 1 will be described as a liquid crystal projector.

The control device 4 is a control device that controls projection performed by the projection apparatus 10. The control device 4 is a device including a control portion composed of various processors, a communication interface (not shown) for communicating with each unit, and a memory 4a such as a hard disk, a solid state drive (SSD), or a read-only memory (ROM) and integrally controls the projection portion 1.

Examples of the various processors of the control portion of the control device 4 include a central processing unit (CPU) that is a general-purpose processor performing various types of processing by executing a program, a programmable logic device (PLD) such as a field programmable gate array (FPGA) that is a processor having a circuit configuration changeable after manufacture, or a dedicated electric circuit such as an application specific integrated circuit (ASIC) that is a processor having a circuit configuration dedicatedly designed to execute specific processing.

More specifically, a structure of these various processors is an electric circuit in which circuit elements such as semiconductor elements are combined. The control portion of the control device 4 may be composed of one of the various processors or may be composed of a combination of two or more processors of the same type or different types (for example, a combination of a plurality of FPGAs or a combination of a CPU and an FPGA).

The operation reception portion 2 detects an instruction from a user by receiving various operations from the user. The operation reception portion 2 may be a button, a key, a joystick, or the like provided in the control device 4 or may be a reception unit or the like that receives a signal from a remote controller that performs remote control of the control device 4.

A projection object 6 is an object such as a screen or a wall having a projection surface on which a projection image is displayed by the projection portion 1. In the example shown in FIG. 1, the projection surface of the projection object 6 is a rectangular plane. It is assumed that upper, lower, left, and right sides of the projection object 6 in FIG. 1 are upper, lower, left, and right sides of the actual projection object 6.

A projection range 11 shown by a one dot chain line is a region irradiated with projection light by the projection portion 1, in the projection object 6. In the example shown in FIG. 1, the projection range 11 is rectangular. The projection range 11 is a part or the entirety of a projectable range within which the projection can be performed by the projection portion 1.

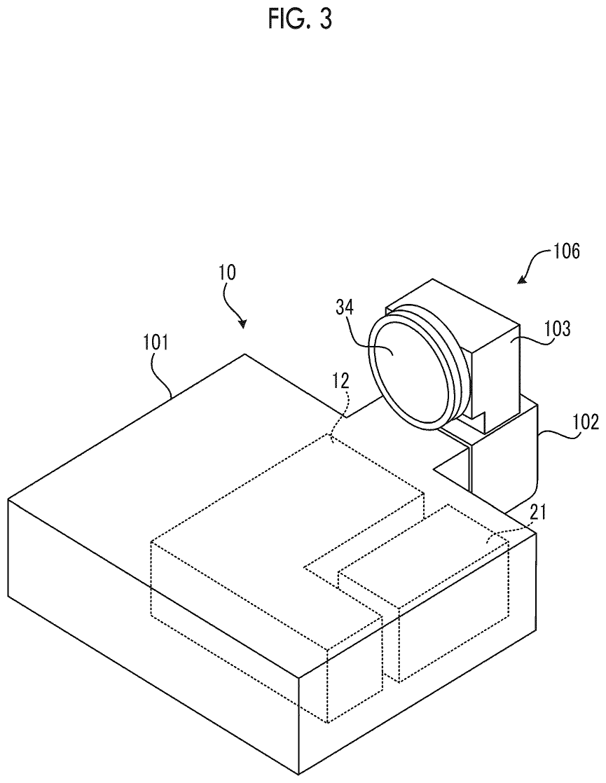

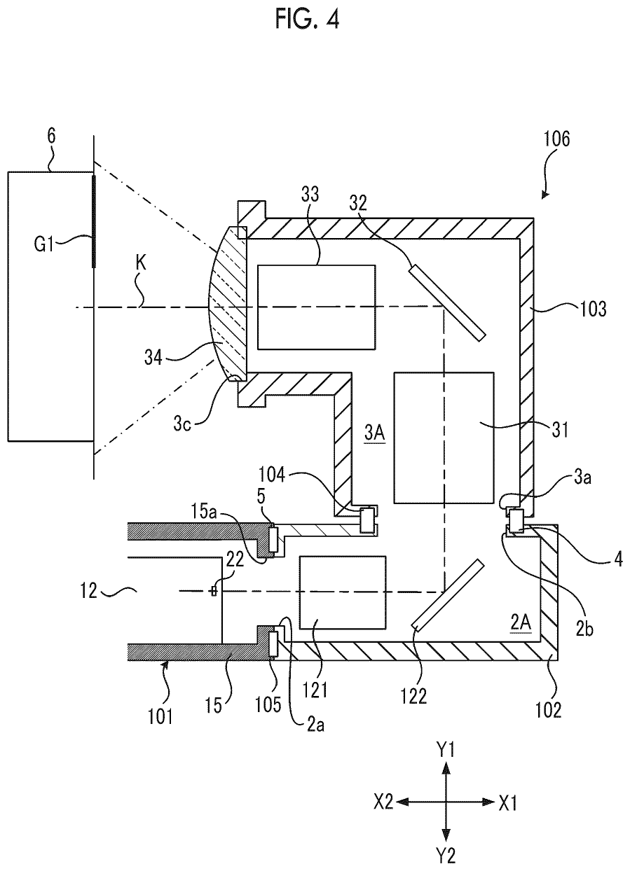

It should be noted that the projection portion 1, the control device 4, and the operation reception portion 2 are implemented by, for example, one device (for example, refer to FIGS. 3 and 4). Alternatively, the projection portion 1, the control device 4, and the operation reception portion 2 may be separate devices that cooperate by performing communication with each other.

### <Internal Configuration of Projection Portion 1 Shown in FIG. 1>

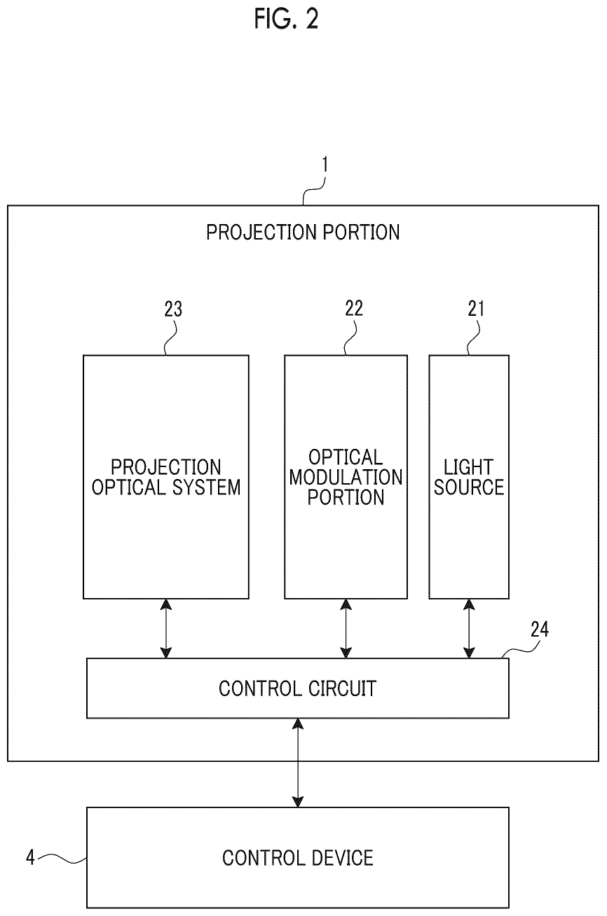

FIG. 2 is a schematic diagram showing an example of an internal configuration of the projection portion 1 shown in FIG. 1.

As shown in FIG. 2, the projection portion 1 comprises a light source 21, an optical modulation portion 22, a projection optical system 23, and a control circuit 24.

The light source 21 includes a light emitting element such as a laser or a light emitting diode (LED) and emits, for example, white light.

The optical modulation portion 22 is composed of three liquid crystal panels that emit each color image by modulating, based on image information, light of each color which is emitted from the light source 21 and separated into three colors, red, blue, and green, by a color separation mechanism, not shown. Each color image may be emitted by respectively mounting filters of red, blue, and green in the three liquid crystal panels and modulating the white light emitted from the light source 21 via each liquid crystal panel.

The light from the light source 21 and the optical modulation portion 22 is incident on the projection optical system 23. The projection optical system 23 includes at least one lens and is composed of, for example, a relay optical system. The light that has passed through the projection optical system 23 is projected to the projection object 6.

In the projection object 6, a region irradiated with the light transmitted through the entire range of the optical modulation portion 22 is the projectable range within which the projection can be performed by the projection portion 1. In the projectable range, a region irradiated with the light actually transmitted through the optical modulation portion 22 is the projection range 11. For example, in the projectable range, a size, a position, and a shape of the projection range 11 are changed by controlling a size, a position, and a shape of a region through which the light is transmitted in the optical modulation portion 22.

The control circuit 24 controls the light source 21, the optical modulation portion 22, and the projection optical system 23 based on display data input from the control device 4 to project an image based on the display data to the projection object 6. The display data input into the control circuit 24 is composed of three pieces of data including red display data, blue display data, and green display data.

In addition, the control circuit 24 enlarges or reduces the projection range 11 (refer to FIG. 1) of the projection portion 1 by changing the projection optical system 23 based on an instruction input from the control device 4. In addition, the control device 4 may move the projection range 11 of the projection portion 1 by changing the projection optical system 23 based on an operation received by the operation reception portion 2 from the user.

In addition, the projection apparatus 10 comprises a shift mechanism that mechanically or optically moves the projection range 11 while maintaining an image circle of the projection optical system 23. The image circle of the projection optical system 23 is a region in which the projection light incident on the projection optical system 23 appropriately passes through the projection optical system 23 in terms of light fall-off, color separation, edge part curvature, and the like.

The shift mechanism is implemented by at least any one of an optical system shift mechanism that performs optical system shifting, or an electronic shift mechanism that performs electronic shifting.

The optical system shift mechanism is, for example, a mechanism (for example, refer to FIGS. 3 and 4) that moves the projection optical system 23 in a direction perpendicular to an optical axis, or a mechanism that moves the optical modulation portion 22 in the direction perpendicular to the optical axis instead of moving the projection optical system 23. In addition, the optical system shift mechanism may perform the movement of the projection optical system 23 and the movement of the optical modulation portion 22 in combination with each other.

The electronic shift mechanism is a mechanism that performs pseudo shifting of the projection range 11 by changing a range through which the light is transmitted in the optical modulation portion 22.

In addition, the projection apparatus 10 may comprise a projection direction changing mechanism that moves the image circle of the projection optical system 23 and the projection range 11. The projection direction changing mechanism is a mechanism that changes a projection direction of the projection portion 1 by changing an orientation of the projection portion 1 via mechanical rotation (for example, refer to FIGS. 3 and 4).

### <Mechanical Configuration of Projection Apparatus 10>

FIG. 3 is a schematic diagram showing an exterior configuration of the projection apparatus 10. FIG. 4 is a schematic cross-sectional view of an optical unit 106 of the projection apparatus 10 shown in FIG. 3. FIG. 4 shows a cross section in a plane along an optical path of light emitted from a body part 101 shown in FIG. 3.

As shown in FIG. 3, the projection apparatus 10 comprises the body part 101 and the optical unit 106 that is provided to protrude from the body part 101. In the configuration shown in FIG. 3, the operation reception portion 2; the control device 4; and the light source 21, the optical modulation portion 22, and the control circuit 24 in the projection portion 1 are provided in the body part 101. The projection optical system 23 in the projection portion 1 is provided in the optical unit 106.

The optical unit 106 comprises a first member 102 supported by the body part 101, and a second member 103 supported by the first member 102.

The first member 102 and the second member 103 may be an integrated member. The optical unit 106 may be configured to be attachable to and detachable from the body part 101 (in other words, configured to be interchangeable).

The body part 101 includes a housing 15 (refer to FIG. 4) in which an opening 15a (refer to FIG. 4) for passing light is formed in a part connected to the optical unit 106.

As shown in FIG. 3, the light source 21 and an optical modulation unit 12 including the optical modulation portion 22 (refer to FIG. 2) that generates an image by spatially modulating the light emitted from the light source 21 based on input image data are provided inside the housing 15 of the body part 101.

The light emitted from the light source 21 is incident on the optical modulation portion 22 of the optical modulation unit 12 and is spatially modulated and emitted by the optical modulation portion 22.

As shown in FIG. 4, the image formed by the light spatially modulated by the optical modulation unit 12 is incident on the optical unit 106 by passing through the opening 15a of the housing 15 and is projected to the projection object 6 as a projection target object. Accordingly, an image G1 is visible from an observer.

As shown in FIG. 4, the optical unit 106 comprises the first member 102 having a hollow portion 2A connected to an inside of the body part 101; the second member 103 having a hollow portion 3A connected to the hollow portion 2A; a first optical system 121 and a reflective member 122 disposed in the hollow portion 2A; a second optical system 31, a reflective member 32, a third optical system 33, and a lens 34 disposed in the hollow portion 3A; a shift mechanism 105; and a projection direction changing mechanism 104.

The first member 102 is a member having, for example, a rectangular cross-sectional exterior, in which an opening 2a and an opening 2b are formed in surfaces perpendicular to each other. The first member 102 is supported by the body part 101 in a state where the opening 2a is disposed at a position facing the opening 15a of the body part 101. The light emitted from the optical modulation portion 22 of the optical modulation unit 12 of the body part 101 is incident into the hollow portion 2A of the first member 102 through the opening 15a and the opening 2a.

An incidence direction of the light incident into the hollow portion 2A from the body part 101 will be referred to as a direction X1. A direction opposite to the direction X1 will be referred to as a direction X2. The direction X1 and the direction X2 will be collectively referred to as a direction X. In addition, a direction from the front to the back of the page of FIG. 4 and its opposite direction will be referred to as a direction Z. In the direction Z, the direction from the front to the back of the page will be referred to as a direction Z1, and the direction from the back to the front of the page will be referred to as a direction Z2.

In addition, a direction perpendicular to the direction X and to the direction Z will be referred to as a direction Y. In the direction Y, an upward direction in FIG. 4 will be referred to as a direction Y1, and a downward direction in FIG. 4 will be referred to as a direction Y2. In the example in FIG. 4, the projection apparatus 10 is disposed such that the direction Y2 is a vertical direction.

The projection optical system 23 shown in FIG. 2 is composed of the first optical system 121, the reflective member 122, the second optical system 31, the reflective member 32, the third optical system 33, and the lens 34. An optical axis K of this projection optical system 23 is shown in FIG. 4. The first optical system 121, the reflective member 122, the second optical system 31, the reflective member 32, the third optical system 33, and the lens 34 are disposed in this order from an optical modulation portion 22 side along the optical axis K.

The first optical system 121 includes at least one lens and guides the light that is incident on the first member 102 from the body part 101 and that travels in the direction X1 to the reflective member 122.

The reflective member 122 reflects the light incident from the first optical system 121 in the direction Y1. The reflective member 122 is composed of, for example, a mirror. In the first member 102, the opening 2b is formed on an optical path of the light reflected by the reflective member 122, and the reflected light travels to the hollow portion 3A of the second member 103 by passing through the opening 2b.

The second member 103 is a member having an approximately T-shaped cross-sectional exterior, in which an opening 3a is formed at a position facing the opening 2b of the first member 102. The light from the body part 101 that has passed through the opening 2b of the first member 102 is incident into the hollow portion 3A of the second member 103 through the opening 3a. The first member 102 and the second member 103 may have any cross-sectional exterior and are not limited to the above.

The second optical system 31 includes at least one lens and guides the light incident from the first member 102 to the reflective member 32.

The reflective member 32 guides the light incident from the second optical system 31 to the third optical system 33 by reflecting the light in the direction X2. The reflective member 32 is composed of, for example, a mirror.

The third optical system 33 includes at least one lens and guides the light reflected by the reflective member 32 to the lens 34.

The lens 34 closes an opening 3c formed in an end part of the second member 103 on a direction X2 side and is disposed in the end part. The lens 34 projects the light incident from the third optical system 33 to the projection object 6.

The projection direction changing mechanism 104 is a rotation mechanism that rotatably connects the second member 103 to the first member 102. By the projection direction changing mechanism 104, the second member 103 is configured to be rotatable about a rotation axis (specifically, the optical axis K) that extends in the direction Y. The projection direction changing mechanism 104 is not limited to a disposition position shown in FIG. 4 as long as the projection direction changing mechanism 104 can rotate the optical system. In addition, the number of rotation mechanisms is not limited to one, and a plurality of rotation mechanisms may be provided.

The shift mechanism 105 is a mechanism for moving the optical axis K of the projection optical system (in other words, the optical unit 106) in a direction (direction Y in FIG. 4) perpendicular to the optical axis K. Specifically, the shift mechanism 105 is configured to be capable of changing a position of the first member 102 in the direction Y with respect to the body part 101. The shift mechanism 105 may manually move the first member 102 or electrically move the first member 102.

FIG. 4 shows a state where the first member 102 is moved as far as possible to a direction Y1 side by the shift mechanism 105. By moving the first member 102 in the direction Y2 via the shift mechanism 105 from the state shown in FIG. 4, a relative position between a center of the image (in other words, a center of a display surface) formed by the optical modulation portion 22 and the optical axis K changes, and the image G1 projected to the projection object 6 can be shifted (translated) in the direction Y2.

The shift mechanism 105 may be a mechanism that moves the optical modulation portion 22 in the direction Y instead of moving the optical unit 106 in the direction Y. Even in this case, the image G1 projected to the projection object 6 can be moved in the direction Y2.

### <Information Processing Apparatus 50 According to Embodiment>

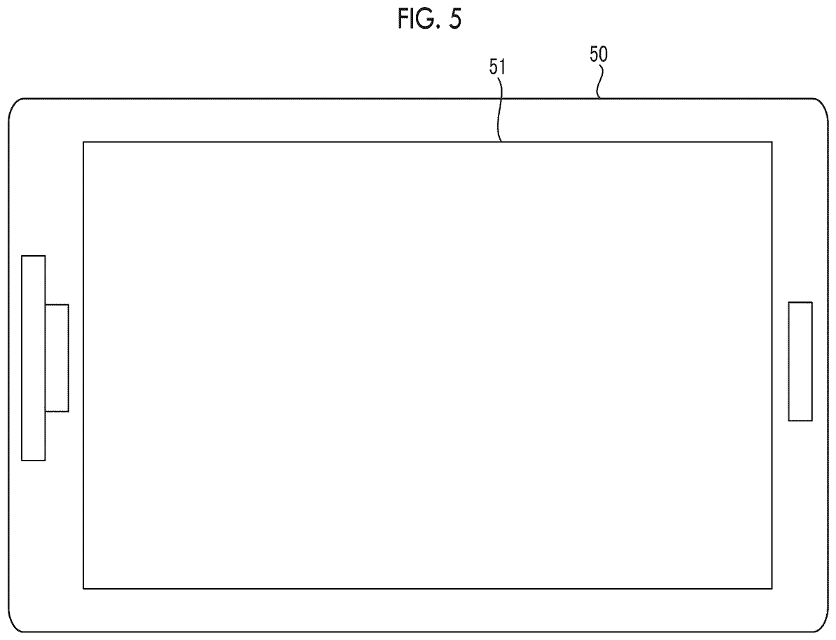

FIG. 5 is a diagram showing an example of an information processing apparatus 50 according to the embodiment. The information processing apparatus 50 according to the embodiment is a tablet terminal including a touch panel 51. The touch panel 51 is a display on which a touch operation can be performed. For example, a user of the information processing apparatus 50 brings the information processing apparatus 50 into a space (for example, a room) in which the projection apparatus 10 is installed and in which projection is performed. The information processing apparatus 50 displays an installation support image for supporting installation of the projection apparatus 10 in the space via the touch panel 51.

### <Hardware Configuration of Information Processing Apparatus 50>

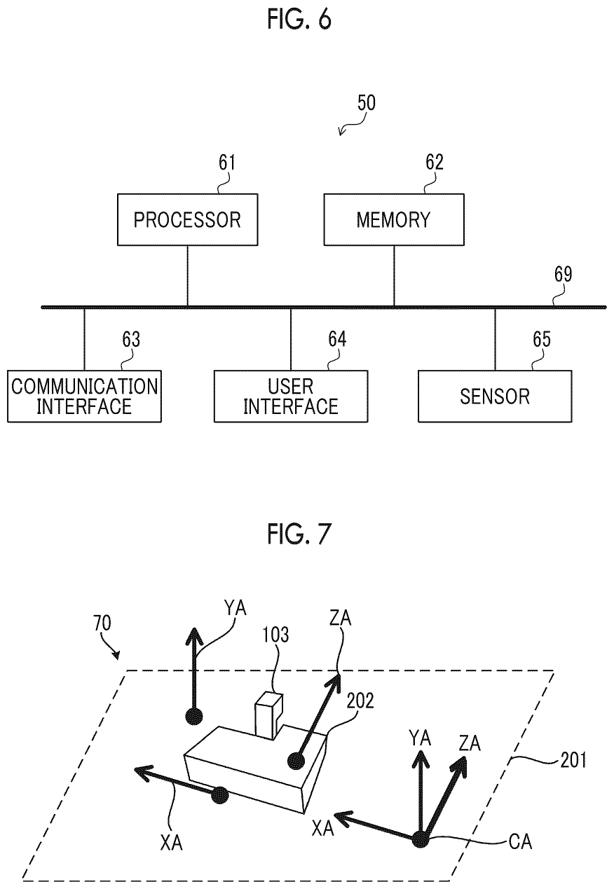

FIG. 6 is a diagram showing an example of a hardware configuration of the information processing apparatus 50 according to the embodiment. The information processing apparatus 50 shown in FIG. 5 comprises, for example, as shown in FIG. 6, a processor 61, a memory 62, a communication interface 63, a user interface 64, and a sensor 65. The processor 61, the memory 62, the communication interface 63, the user interface 64, and the sensor 65 are connected by, for example, a bus 69.

The processor 61 is a circuit that performs signal processing, and is, for example, a CPU that controls the entire information processing apparatus 50. The processor 61 may be implemented by other digital circuits such as an FPGA and a digital signal processor (DSP). In addition, the processor 61 may be implemented by combining a plurality of digital circuits.

The memory 62 includes, for example, a main memory and an auxiliary memory. The main memory is, for example, a random-access memory (RAM). The main memory is used as a work area of the processor 61.

The auxiliary memory is, for example, a non-volatile memory such as a magnetic disk or a flash memory. Various programs for operating the information processing apparatus 50 are stored in the auxiliary memory. The programs stored in the auxiliary memory are loaded into the main memory and executed by the processor 61.

In addition, the auxiliary memory may include a portable memory that can be attached to and detached from the information processing apparatus 50. Examples of the portable memory include a memory card such as a universal serial bus (USB) flash drive or a secure digital (SD) memory card, and an external hard disk drive.

The communication interface 63 is a communication interface that performs communication with an external device of the information processing apparatus 50. The communication interface 63 includes at least any one of a wired communication interface for performing wired communication or a wireless communication interface for performing wireless communication. The communication interface 63 is controlled by the processor 61.

The user interface 64 includes, for example, an input device that receives operation input from a user, and an output device that outputs information to the user. The input device can be implemented by, for example, a key (for example, a keyboard) or a remote controller. The output device can be implemented by, for example, a display or a speaker. In the information processing apparatus 50 shown in FIG. 5, the input device and the output device are implemented by the touch panel 51. The user interface 64 is controlled by the processor 61.

The sensor 65 includes an imaging device that includes an imaging optical system and an imaging element and that can perform imaging, a space recognition sensor that can three-dimensionally recognize a space around the information processing apparatus 50, and the like. The imaging device includes, for example, an imaging device provided on a rear surface of the information processing apparatus 50 shown in FIG. 5.

The space recognition sensor is, as an example, light detection and ranging (LIDAR) of performing irradiation with laser light, measuring a time taken until the laser light of irradiation hits an object and reflects back, and measuring a distance and a direction to the object. However, the space recognition sensor is not limited thereto and can be various sensors such as radar that emits radio waves, and an ultrasonic sensor that emits an ultrasound wave.

### <Definition of Virtual Projection Apparatus 202, Virtual Projection Surface 204, and Coordinate System>

FIGS. 7 to 9 are diagrams illustrating a virtual projection apparatus 202 and a virtual projection surface 204 displayed on the touch panel 51 of the information processing apparatus 50 in correspondence with the projection apparatus 10 and the projection range 11 (FIG. 1). In addition, in FIGS. 7 to 9, respective coordinate systems of the virtual projection apparatus 202 and the virtual projection surface 204 are defined. It should be noted that such a definition of a coordinate system is merely an example, and another coordinate system can be adopted. In addition, in the present example, the different coordinate systems are provided to the virtual projection apparatus 202 and the virtual projection surface 204, but a common coordinate system may be applied to the virtual projection apparatus 202 and the virtual projection surface 204.

The virtual projection apparatus 202 and the virtual projection surface 204 are superimposed and disposed on a space image 70 displayed on the touch panel 51. For example, the information processing apparatus 50 generates correspondence information between positional coordinates in a space three-dimensionally recognized by the space recognition sensor comprised as the sensor 65 and positional coordinates in the space image 70 two-dimensionally displayed by the touch panel 51. Further, the information processing apparatus 50 generates correspondence information between positional coordinates of the virtual projection apparatus 202 and the virtual projection surface 204, which are virtually disposed in the space recognized above, and positional coordinates of the space image 70. As a result, the information processing apparatus 50 can superimpose and dispose the virtual projection apparatus 202 and the virtual projection surface 204 on the space image 70.

FIG. 7 is a diagram illustrating an example of the coordinate system of the virtual projection apparatus 202 corresponding to the projection apparatus 10. A projection apparatus installation virtual surface 201 corresponding to a floor surface or the like in an actual space is set in the space image 70. Then, the virtual projection apparatus 202 is disposed on the projection apparatus installation virtual surface 201. That is, the virtual projection surface 204 is disposed in a space indicated by the space image 70. The projection apparatus installation virtual surface 201 is parallel to a bottom surface of the virtual projection apparatus 202 and overlaps the bottom surface.

A projection apparatus coordinate system CA, which is the coordinate system of the virtual projection apparatus 202, is defined by a three-dimensional orthogonal coordinate system including an XA axis along a left-right direction of the virtual projection apparatus 202, a ZA axis along a front-rear direction of the virtual projection apparatus 202, and a YA axis perpendicular to the projection apparatus installation virtual surface 201. In the present figure, the projection direction changing mechanism 104 (FIG. 4) disposes the second member 103 such that the second member 103 is directed in a direction perpendicular to the projection apparatus installation virtual surface 201. In this case, the projection apparatus installation virtual surface 201 and a projection surface installation virtual surface 203 (refer to FIG. 9) do not face each other (non-facing).

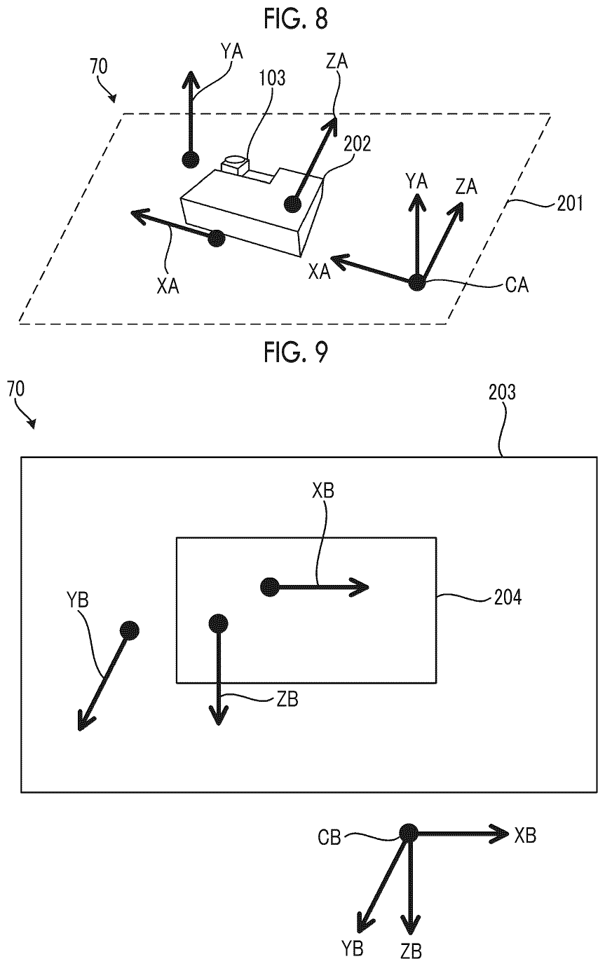

FIG. 8 is another diagram illustrating an example of the coordinate system of the virtual projection apparatus 202. In the present figure, the projection direction changing mechanism 104 disposes the second member 103 such that the second member 103 is directed in a direction parallel to the projection apparatus installation virtual surface 201. In this case, the projection apparatus installation virtual surface 201 and the projection surface installation virtual surface 203 (refer to FIG. 9) face each other. As shown in FIGS. 8 and 9, the projection apparatus coordinate system CA is defined regardless of a position of the second member 103.

FIG. 9 is a diagram illustrating an example of the coordinate system of the virtual projection surface 204 corresponding to the projection range 11. The projection surface installation virtual surface 203 corresponding to the projection object 6 (FIG. 1) is set in the space image 70, and the virtual projection surface 204 is disposed on the projection surface installation virtual surface 203. That is, the virtual projection surface 204 is disposed in the space indicated by the space image 70.

The projection surface coordinate system CB, which is the coordinate system of the virtual projection surface 204, is defined by a three-dimensional orthogonal coordinate system including an XB axis along a shift direction in a horizontal direction of the projection range 11, a ZB axis along a shift direction in a vertical direction of the projection range 11, and a YB axis perpendicular to the projection surface installation virtual surface 203, which are used by the shift mechanism 105 (FIG. 4).

### <Overview of Information Processing Performed by Information Processing Apparatus 50 According to Embodiment>

A technology of simulating the projection of the projection apparatus by using an augmented reality (AR) function of a smart device has been reviewed. This technology relates to installation of a virtual object such as the virtual projection apparatus 202 and the projection apparatus installation virtual surface 201 as described above, and a specific method of adjusting a position after the installation, a size, and the like of the virtual object is important.

In AR, it is not easy to set the position of the virtual object as intended at the time of installation because the virtual object is displayed on a screen as a two-dimensional image obtained by imaging a three-dimensional space with an imaging device. Therefore, the user is required to finely adjust the position of the virtual object after the installation of the virtual object, but an appropriate method has not been proposed, which is a burden on the user.

The information processing apparatus 50 according to the present embodiment can reduce a burden on the user related to installation work of the virtual projection apparatus 202 and the virtual projection surface 204.

### <Processing Performed by Information Processing Apparatus 50 According to Embodiment>

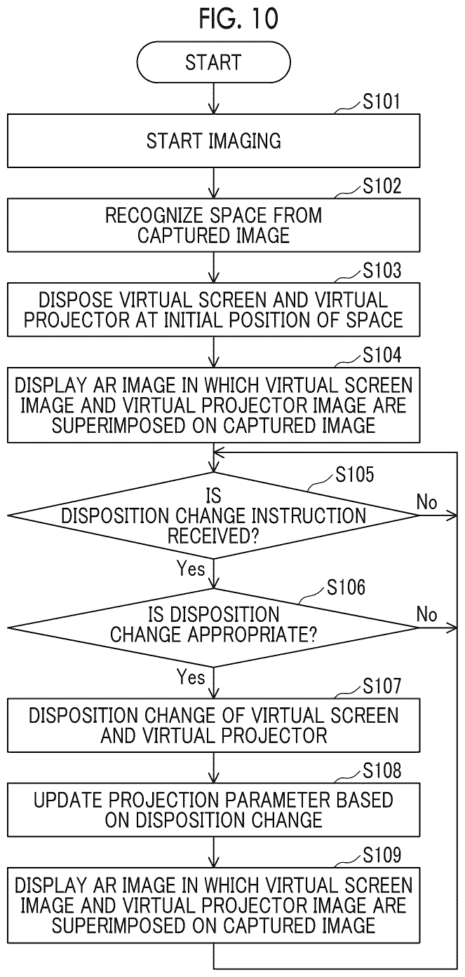

FIG. 10 is a flowchart showing an example of processing performed by the information processing apparatus 50 according to the embodiment. The information processing apparatus 50 according to the embodiment executes processing shown in FIG. 10, for example. The processing in FIG. 10 is executed by, for example, the processor 61 shown in FIG. 6.

In a case where the sensor 65, which is the imaging device, starts the imaging (step S101), the information processing apparatus 50 recognizes a space from a captured image obtained by the sensor 65 (step S102). Here, the information processing apparatus 50 acquires first image data representing a first image, which is, for example, the space image 70, in the recognition of the space. In the present embodiment, the sensor 65, which is the imaging device, is integrally configured with the information processing apparatus 50, but may be an external device that is separate from the information processing apparatus 50. Next, the information processing apparatus 50 disposes a virtual screen (virtual projection surface) and a virtual projector (virtual projection apparatus) at an initial position of the space (first image data) (step S103). Here, the information processing apparatus 50 acquires disposition data related to a disposition of the virtual screen and the virtual projector in the space indicated by the first image. The disposition data is data corresponding to a current disposition of the virtual screen and the virtual projector, and shows, for example, a disposition of the virtual screen and the virtual projector in an initial state.

Next, the information processing apparatus 50 displays an AR image, in which a virtual screen image and a virtual projector image are superimposed on the captured image, on the touch panel 51 as a display device that is an output destination (step S104).

Next, the information processing apparatus 50 determines whether or not a disposition change instruction of the virtual screen image and/or the virtual projector image is received via the operation of the user on the touch panel 51 (step S105). Here, in a case where the information processing apparatus 50 receives the disposition change instruction, disposition change data related to a disposition change of the virtual screen and/or the virtual projector in the first image is acquired.

In a case where the information processing apparatus 50 receives the disposition change instruction (step S105: Yes), the information processing apparatus 50 determines whether or not the disposition change is appropriate (step S106). The determination as to whether or not the disposition change is appropriate is, for example, a determination as to whether or not the disposition change is actually possible based on a recognition result of the space in step S102. In a case where the disposition change is appropriate (step S106: Yes), the information processing apparatus 50 performs the disposition change of the virtual screen and the virtual projector (step S107).

Next, the information processing apparatus 50 updates a projection parameter based on the disposition change (step S108). This means that the information processing apparatus 50 generates second image data representing a second image in which the virtual screen and/or the virtual projector of which the disposition is changed based on the disposition change data is displayed on the first image.

Next, the information processing apparatus 50 displays the AR image, in which the virtual screen image and the virtual projector image are superimposed on the captured image, on the touch panel 51 (step S109), and waits for a next disposition change instruction. This means that the information processing apparatus 50 outputs the second image data to the touch panel 51 that is the output destination. In the present embodiment, the touch panel 51, which is the output destination, is integrally configured with the information processing apparatus 50, but may be an external device that is separate from the information processing apparatus 50.

In a case where the information processing apparatus 50 does not receive the disposition change instruction (step S105: No) or in a case where the disposition change is not appropriate (step S106: No), the information processing apparatus 50 waits for a next disposition change instruction.

### <User Interface 64 of Information Processing Apparatus 50 According to Embodiment>

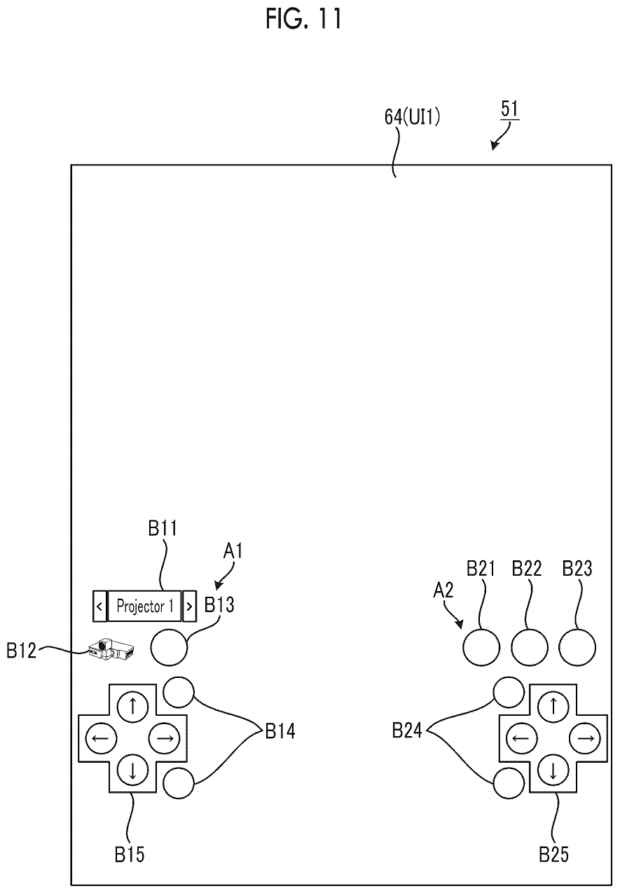

FIGS. 11 to 17 are diagrams illustrating the user interface 64 (FIG. 6) with which the user operates the information processing apparatus 50, particularly the virtual projection apparatus 202 or the virtual projection surface 204. The user interface 64 of FIGS. 11 to 17 is displayed on the touch panel 51 that is the output device (output destination). That is, the touch panel 51 also functions as an input receiver that receives input of the disposition change data related to the disposition change of the virtual projection apparatus 202 or the virtual projection surface 204 from the user. Note that the shown user interface 64 is merely an example, and the user interface applicable to the information processing apparatus 50 is not particularly limited.

The operation input of the user may be, for example, a pressing of a physical button, a gesture such as a tap, a pan, or a pinch on a touch screen, a voice, a gesture on a camera, or numerical input.

Although only a part of the user interface 64 is shown in FIG. 11, the touch panel 51 also displays the virtual projection apparatus 202 and the virtual projection surface 204 in actual specification. Here, the virtual projection apparatus 202 and the virtual projection surface 204 are not shown.

FIG. 11 is an example of the user interface 64 displayed by the information processing apparatus 50 according to the embodiment, and is an operation image UI1 in which the touch panel 51 displays a plurality of buttons. The user can operate the virtual projection apparatus 202 or the virtual projection surface 204 by pressing the various buttons described below. That is, the information processing apparatus 50 receives the input of the disposition change data related to the disposition change of the virtual projection apparatus 202 or the virtual projection surface 204 from the user via the user interface 64. In this case, the information processing apparatus 50 can perform control of displaying, on the touch panel 51, an image (operation image UI1) including an operation image for giving an instruction to perform the disposition change of the virtual projection surface 204 and an operation image for giving an instruction to perform the disposition change of the virtual projection apparatus 202.

The operation image UI1 includes a virtual projection apparatus operation region A1 and a virtual projection surface operation region A2. The virtual projection apparatus operation region A1 is a user interface region for operating the virtual projection apparatus 202. The virtual projection apparatus operation region A1 includes an operation target switching button B11, a posture change button B12, a rotation button B13, an up/down movement button B14, and a front/rear/left/right movement button B15.

The operation target switching button B11 is a button for switching the virtual projection apparatus 202 that is an operation target in a case where a plurality of virtual projection apparatuses 202 are installed. The posture change button B12 is a button for changing a posture (orientation) of the virtual projection apparatus 202. The rotation button B13 is a button for rotating the posture (orientation) of the virtual projection apparatus 202. The up/down movement button B14 is a button for moving the virtual projection apparatus 202 in an up-down direction. The front/rear/left/right movement button B15 is a button for moving the virtual projection apparatus 202 in the front, rear, left, and right directions.

The virtual projection surface operation region A2 is a user interface region for operating the virtual projection surface 204. The virtual projection surface operation region A2 includes an aspect ratio change button B21, an image setting button B22, an image rotation button B23, a projection surface rotation button B24, and an up/down/left/right movement button B25.

The aspect ratio change button B21 is a button for changing an aspect ratio of the virtual projection surface 204. The image setting button B22 is a button for setting an image on the virtual projection surface 204. The image rotation button B23 is a button for rotating the image set on the virtual projection surface 204. The projection surface rotation button B24 is a button for rotating the virtual projection surface 204. The up/down/left/right movement button B25 is a button for moving the virtual projection surface 204 in the up, down, left, and right directions.

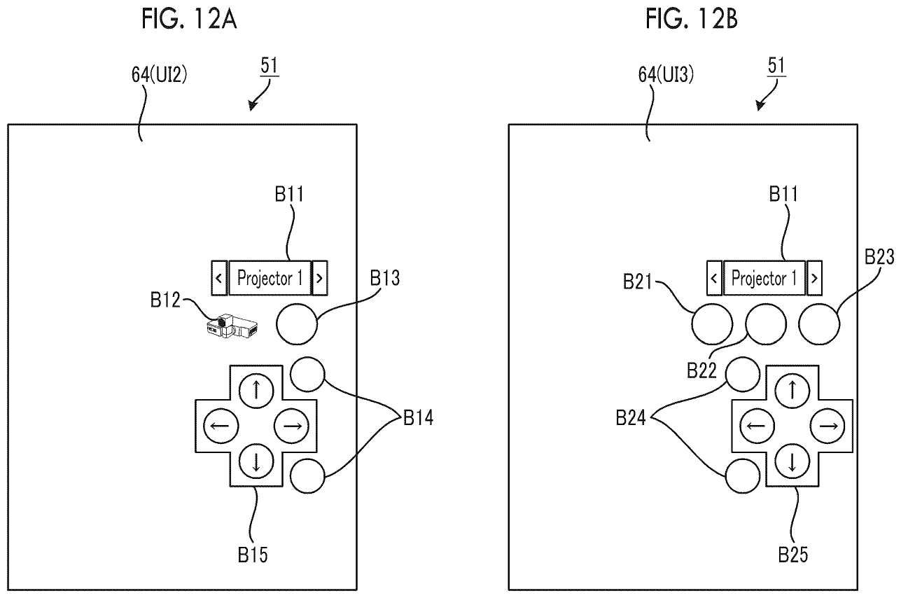

FIGS. 12A and 12B are other examples of the user interface 64 displayed by the information processing apparatus 50 according to the embodiment, and are, for example, operation images in which the plurality of buttons are displayed by the touch panel 51 of a smartphone that is the information processing apparatus 50.

An operation image UI2 shown in FIG. 12A performs a display corresponding to the virtual projection apparatus operation region A1 of FIG. 11, and is an image for operating the virtual projection apparatus 202. An operation image UI3 shown in FIG. 12B performs a display corresponding to the virtual projection surface operation region A2 of FIG. 11, and is an image for operating the virtual projection surface 204.

Although only a part of the user interface 64 is shown in FIGS. 12A and 12B, the touch panel 51 also displays the virtual projection apparatus 202 and the virtual projection surface 204 in actual specification. Here, the virtual projection apparatus 202 and the virtual projection surface 204 are not shown.

That is, the information processing apparatus 50 receives the input of the disposition change data related to the disposition change of the virtual projection apparatus 202 or the virtual projection surface 204 from the user via the user interface 64. In this case, the information processing apparatus 50 can perform control of switching between a state in which the operation image U13 for giving an instruction to perform the disposition change of the virtual projection surface 204 is displayed on the touch panel 51 and a state in which the operation image UI2 for giving an instruction to perform the disposition change of the virtual projection apparatus 202 is displayed on the touch panel 51. The user can switch between the images of FIGS. 12A and 12B and operate the virtual projection apparatus 202 or the virtual projection surface 204 by performing a predetermined operation (tap on the touch panel 51 or the like).

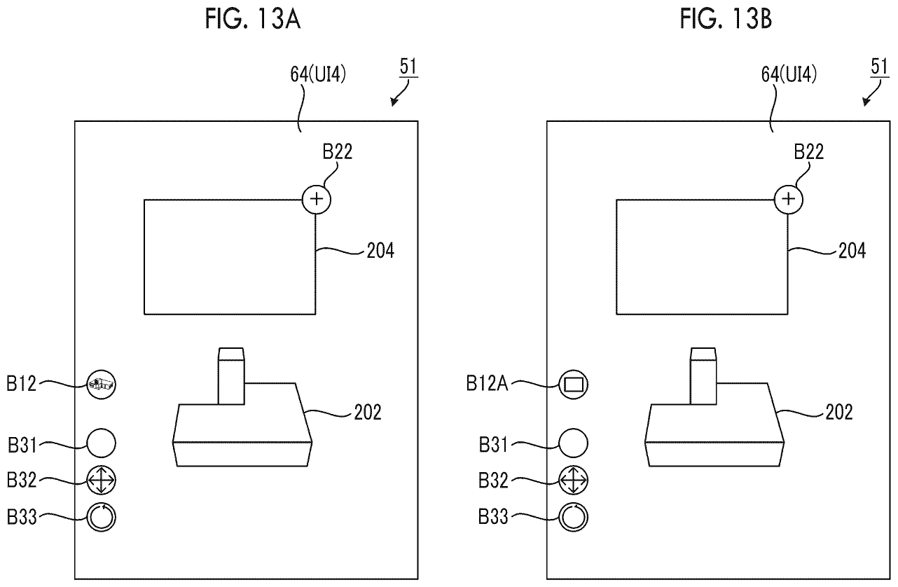

FIGS. 13A and 13B are other examples of the user interface 64 displayed by the information processing apparatus 50 according to the embodiment, and are, for example, operation images in which the plurality of buttons are displayed by the touch panel 51 of a tablet that is the information processing apparatus 50. An operation image U14 shown in FIGS. 13A and 13B is a type of an input device implemented by the user interface 64, and is displayed on the touch panel 51 of the information processing apparatus 50 that is, for example, a smartphone. The operation image UI4 shown in FIG. 13A is a screen in which the user selects the virtual projection apparatus 202 as an operation target by tapping a region of the virtual projection apparatus 202. The operation image UI4 shown in FIG. 13B is a screen in which the user selects the virtual projection surface 204 as an operation target by tapping a region of the virtual projection surface 204.

In the operation image U14 of FIG. 13A, the virtual projection apparatus 202 is selected as an operation target, but the operation of the user with respect to the virtual projection apparatus 202 is locked in an initial state. Therefore, the user cannot operate the virtual projection apparatus 202 in the initial state of FIG. 13A.

In the operation image UI4 of FIG. 13A, a size change lock release button B31, a horizontal movement lock release button B32, and a rotation lock release button B33 are displayed in addition to the posture change button B12 and the image setting button B22 of FIG. 11. The size change lock release button B31 is a button for releasing a size change of the virtual projection apparatus 202 that is locked in the initial state. The horizontal movement lock release button B32 is a button for releasing horizontal movement of the virtual projection apparatus 202 that is locked in the initial state. The rotation lock release button B33 is a button for releasing the rotation of the virtual projection apparatus 202 that is locked in the initial state.

On the other hand, in the operation image UI4 of FIG. 13B, the virtual projection surface 204 is selected as an operation target, but the operation of the user with respect to the virtual projection surface 204 is locked in the initial state. Therefore, the user cannot operate the virtual projection surface 204 in the initial state of FIG. 13B.

In the operation image U14 of FIG. 13B, the size change lock release button B31, the horizontal movement lock release button B32, and the rotation lock release button B33 are displayed as in the screen of FIG. 13A in addition to a posture change button B12A for the virtual projection surface 204 and the image setting button B22 of FIG. 11. The size change lock release button B31 is a button for releasing a size change of the virtual projection surface 204 that is locked in the initial state. The horizontal movement lock release button B32 is a button for releasing horizontal movement of the virtual projection surface 204 that is locked in the initial state. The rotation lock release button B33 is a button for releasing the rotation of the virtual projection surface 204 that is locked in the initial state.

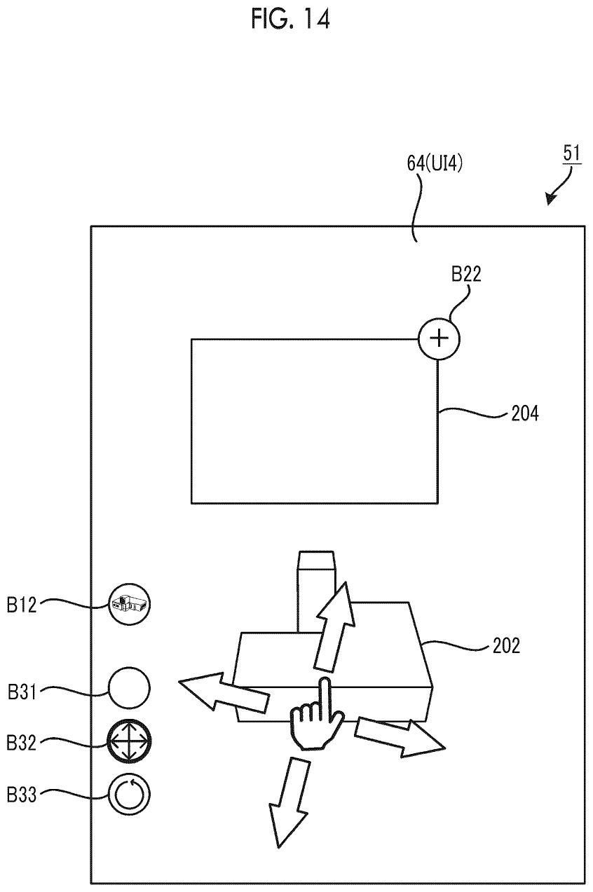

FIG. 14 is a diagram showing an operation of horizontally moving the virtual projection apparatus 202 in the operation image UI4 of FIG. 13A. The horizontal movement of the virtual projection apparatus 202 is released by the user pressing the horizontal movement lock release button B32. Further, the virtual projection apparatus 202 can be moved in the horizontal direction by the user tracing the touch panel 51 with a finger in a straight line direction (pan gesture).

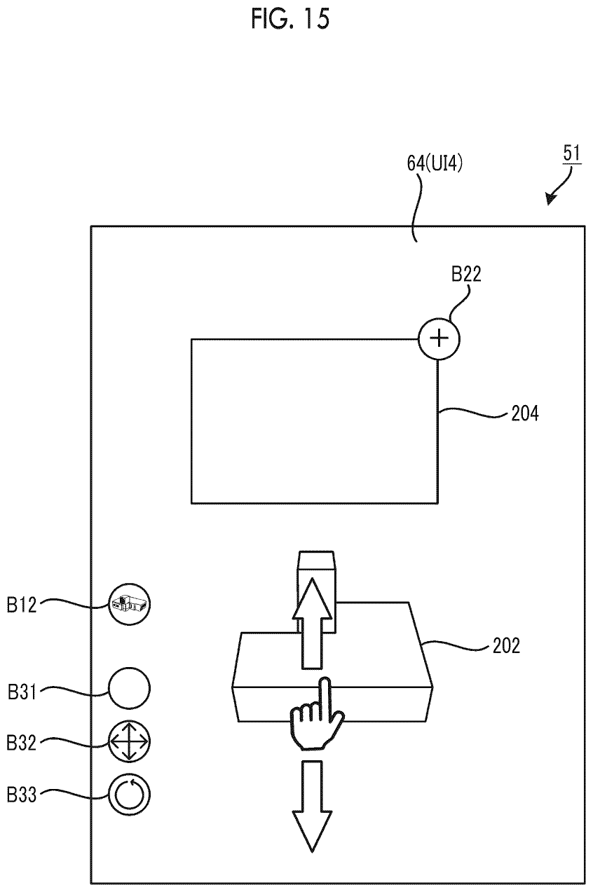

FIG. 15 is a diagram showing an operation of moving the virtual projection apparatus 202 up and down in the operation image UI4 of FIG. 13A. The user can move the virtual projection apparatus 202 in the up-down direction by tracing the touch panel 51 with a finger in a straight line direction (pan gesture).

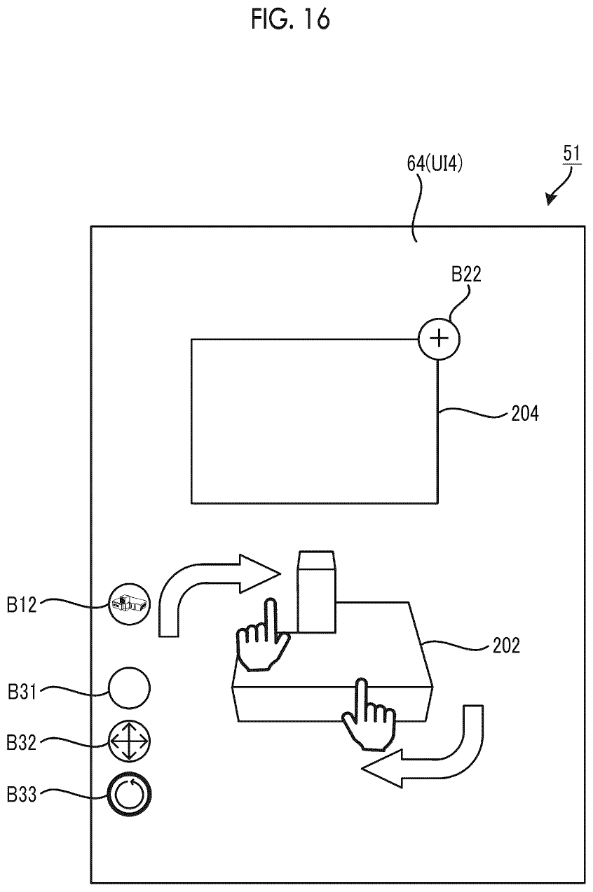

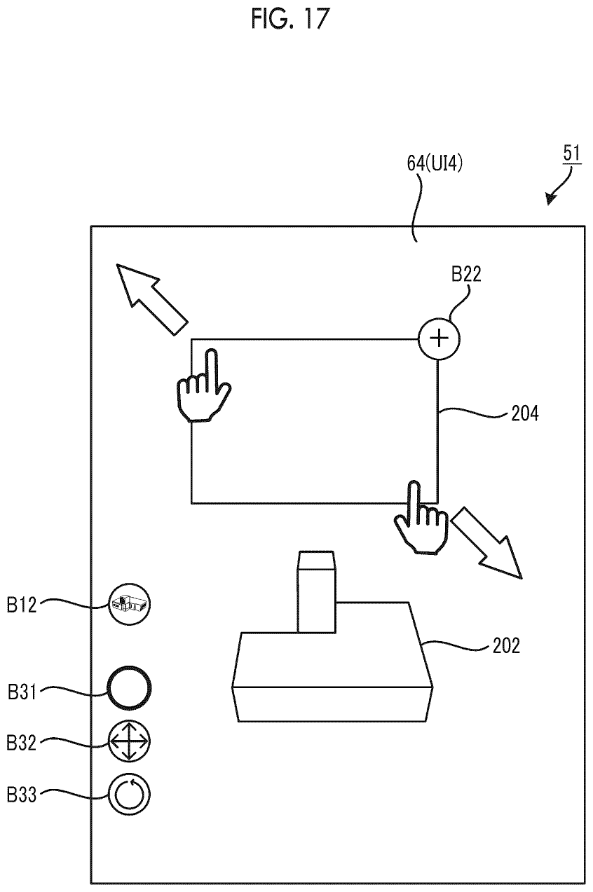

FIG. 16 is a diagram showing an operation of rotating the virtual projection apparatus 202 in the operation image UI4 of FIG. 13A. The rotation of the virtual projection apparatus 202 is released by the user pressing the rotation lock release button B33. Further, the virtual projection apparatus 202 can be rotated by the user tracing the touch panel 51 with a finger in a circular direction (rotation gesture).

FIG. 17 is a diagram showing an operation of changing a size of the virtual projection surface 204 in the operation image UI4 of FIG. 13B. The size change of the virtual projection surface 204 is released by the user pressing the size change lock release button B31. Further, the size of the virtual projection surface 204 can be changed by the user tracing the touch panel 51 with fingers such that the user reduces or expands the region of the virtual projection surface 204 (pinch gesture).

That is, the information processing apparatus 50 can perform at least any one of control of changing the disposition of the virtual projection surface 204 according to the operation performed by the user on the virtual projection surface 204 in the second image displayed on the touch panel 51, or control of changing the disposition of the virtual projection apparatus 202 according to the operation performed by the user on the virtual projection apparatus 202 in the second image displayed on the touch panel 51.

### <Details of Processing Performed by Information Processing Apparatus 50 According to Embodiment>

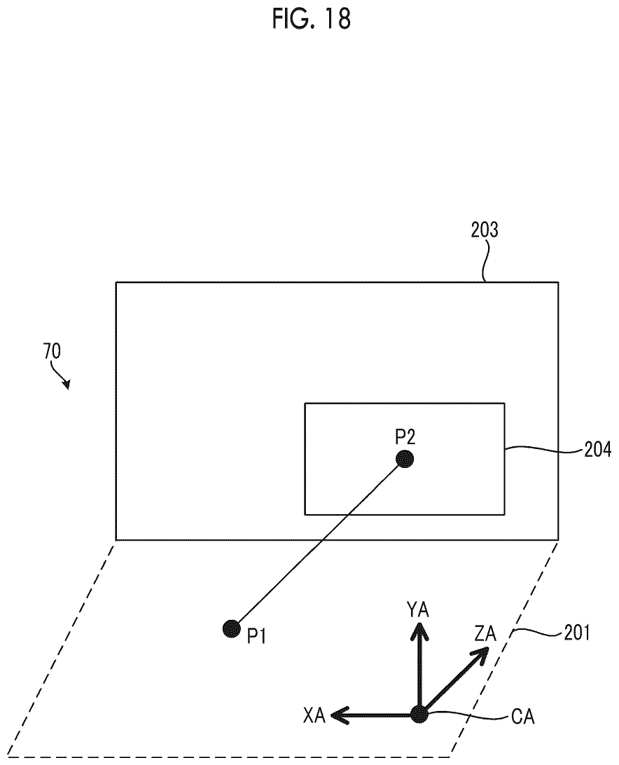

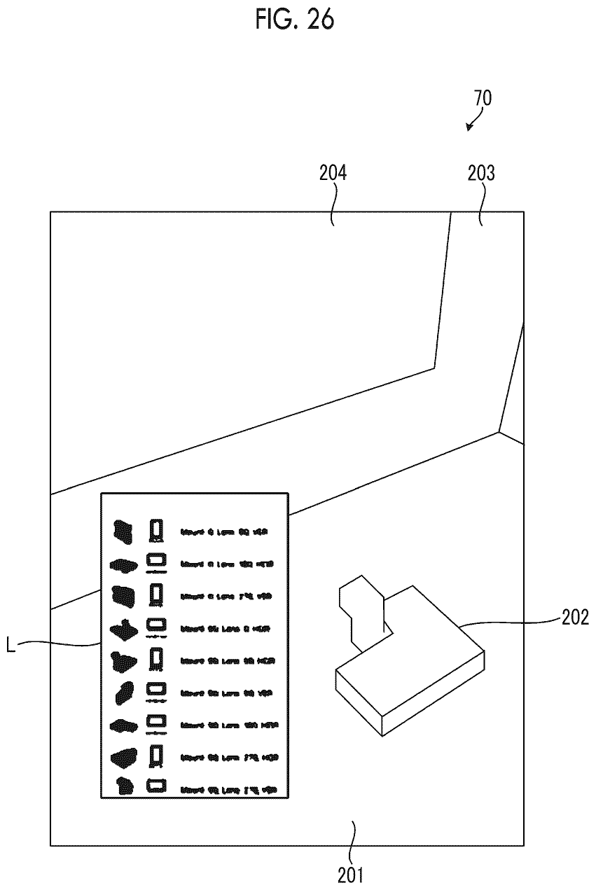

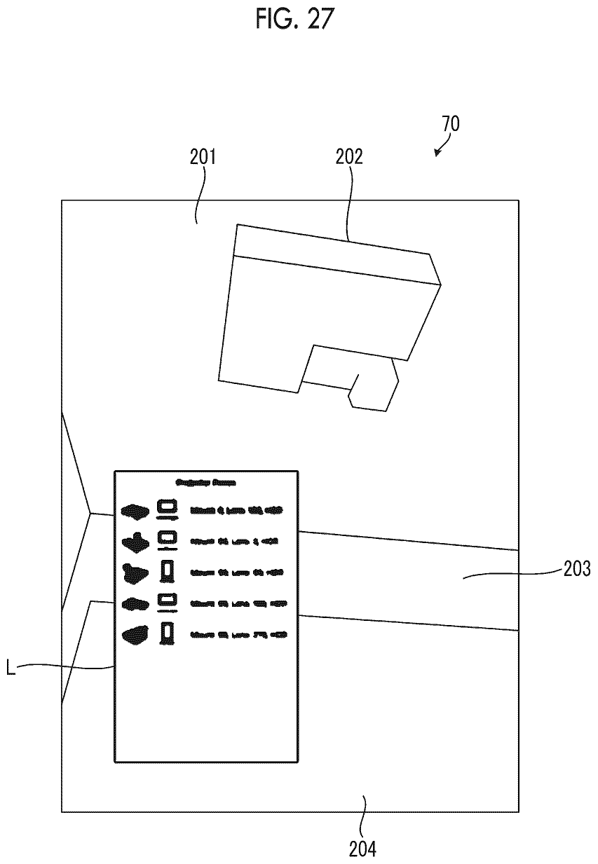

FIGS. 18 to 37 are diagrams illustrating details of information processing performed by the information processing apparatus 50 in association with the disposition change of the virtual projection apparatus 202 or the virtual projection surface 204. FIGS. 18 to 24, 28 to 37 are simulation diagrams obtained as a result of performing, in a simulated manner, operations of changing the positions, changing the directions, changing the sizes, and the like of the virtual projection apparatus 202 and the virtual projection surface 204 in the space image 70 (FIGS. 7 to 9) that is the first image after the superimposed disposition of the virtual projection apparatus 202 and the virtual projection surface 204. The virtual projection apparatus 202 is not shown in the simulation diagram. On the other hand, FIGS. 26 and 27 show images displayed on the touch panel 51 based on the simulation. Control described below is executed by, for example, the processor 61 shown in FIG. 6.

### <Virtual Projection Apparatus Priority Mode and Virtual Projection Surface Priority Mode>

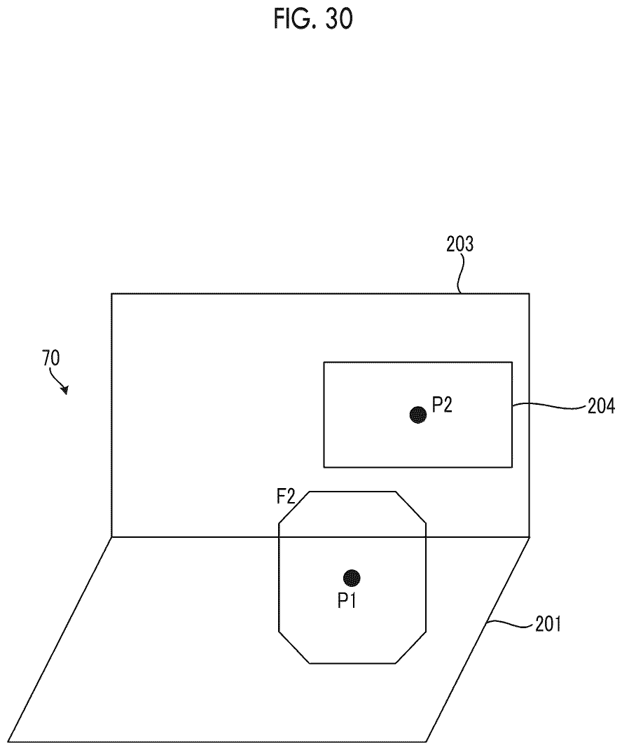

The information processing apparatus 50 operates in two modes, that is, a virtual projection apparatus priority mode and a virtual projection surface priority mode. First, the information processing apparatus 50 can specify the position, the direction, and the size of the virtual projection surface 204 according to the position and the direction of the virtual projection apparatus 202. In the present specification, such control is referred to as a “virtual projection apparatus priority mode”. In addition, the information processing apparatus 50 can specify an installable range of the virtual projection apparatus 202 and the position of the virtual projection apparatus 202 according to the position, the direction, and the size of the virtual projection surface 204. In the present specification, such control is referred to as a “virtual projection surface priority mode”. Hereinafter, FIGS. 18 to 29 show examples of control via the virtual projection apparatus priority mode, and FIGS. 30 to 37 show examples of control via the virtual projection surface priority mode. Note that the division of the operation modes of the information processing apparatus 50 is merely an example.

### <Movement of Virtual Projection Apparatus 202 in Virtual Projection Apparatus Priority Mode>

FIGS. 18 to 22 are simulation diagrams of an example in which the user gives an instruction to move the virtual projection apparatus 202, that is, to change the position of the virtual projection apparatus 202, in the virtual projection apparatus priority mode.

FIG. 18 is a simulation diagram in an initial state in the virtual projection apparatus priority mode. The initial state refers to a state in which a projection center point in a state in which the movement of the projection range 11 by the shift mechanism of the projection apparatus 10 (hereinafter, also referred to as “lens shift”) is not executed is present on the virtual projection surface 204; the virtual projection apparatus 202 faces the projection center point without the lens shift; and the virtual projection surface 204 corresponds to the orientation of the virtual projection apparatus 202 or the virtual projection apparatus 202 corresponds to an orientation of the virtual projection surface 204. The initial state is implemented by disposition data corresponding to a current disposition of the virtual projection surface 204 and the virtual projection apparatus 202.

As a premise of the initial state, the information processing apparatus 50 acquires the first image data representing the first image, which is the space image 70 obtained by imaging with the sensor 65 that is the imaging device, and acquires the disposition data related to the disposition of the virtual projection surface 204 and the virtual projection apparatus 202 in the space indicated by the first image. This content is common in an initial state, which will be described later.

The coordinates of the virtual projection apparatus 202 conform to the projection apparatus coordinate system CA described with reference to FIG. 7, and the projection direction changing mechanism 104 (FIG. 4) disposes the second member 103 such that the second member 103 is directed in the direction perpendicular to the projection apparatus installation virtual surface 201. As described above, the projection apparatus coordinate system CA includes the XA axis along the left-right direction of the virtual projection apparatus 202, the ZA axis along the front-rear direction of the virtual projection apparatus 202, and the YA axis perpendicular to the projection apparatus installation virtual surface 201. The ZA axis is also along an optical axis of the virtual projection apparatus 202. The YA axis is along a normal direction of the projection apparatus installation virtual surface 201. A point P1 is a lens center point of the virtual projection apparatus 202, and a point P2 is a projection center point of the virtual projection surface 204 without the lens shift.

The user operates any one of the user interfaces 64 shown in FIGS. 11 to 17, whereby the virtual projection apparatus 202 is moved in the space image 70 (first image).

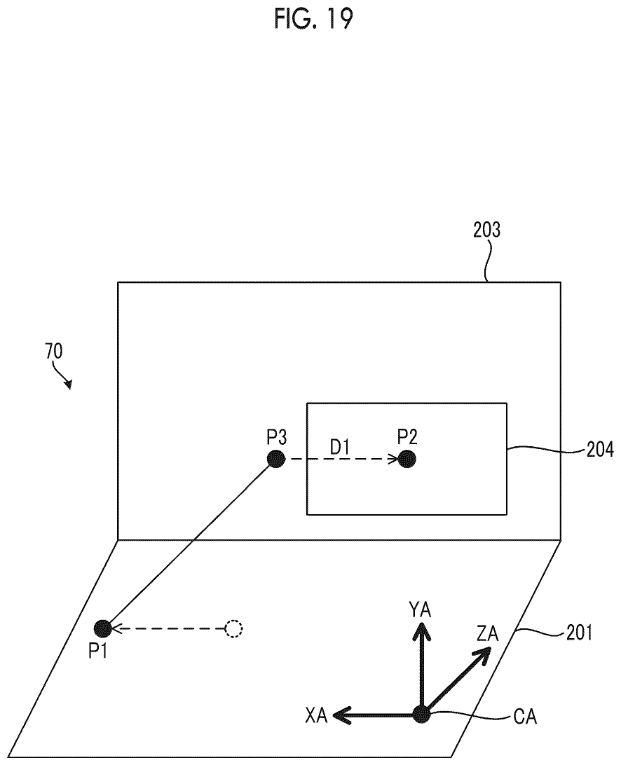

The user can change the position of the virtual projection apparatus 202 by, for example, pressing the front/rear/left/right movement button B15 (FIG. 11). FIG. 19 is a diagram illustrating movement of the virtual projection apparatus 202 in the left direction, that is, movement in an XA axis positive direction. The user can instruct the information processing apparatus 50 to perform such movement by pressing a left button of the front/rear/left/right movement button B15. Movement of the virtual projection apparatus 202 in the right direction, that is, movement in an XA axis negative direction can be indicated by pressing a right button of the front/rear/left/right movement button B15.

The change in the position of the virtual projection apparatus 202 means that the information processing apparatus 50 acquires the disposition change data related to the disposition change of the virtual projection surface 204 and/or the virtual projection apparatus 202 in the first image (space image 70). In addition, the change also means that the information processing apparatus 50 generates the second image data representing the second image in which the virtual projection surface 204 and/or the virtual projection apparatus 202 of which the disposition is changed based on the disposition change data is displayed on the first image. In the present example, the information processing apparatus 50 acquires the disposition change data related to the disposition change of the virtual projection apparatus 202, and generates the second image data representing the second image of the virtual projection apparatus 202 of which the disposition is changed. The acquisition of the disposition change data and the generation of the second image data are common in all examples described below. In the present specification, the disposition change data includes data for giving an instruction to change at least any one of the position of the virtual projection surface 204 and/or the virtual projection apparatus 202, the direction (orientation) of the virtual projection surface 204 and/or the virtual projection apparatus 202, or the size of the virtual projection surface 204, and the disposition change data will be described in the examples described below.

In this case, the information processing apparatus 50 changes the position of the virtual projection apparatus 202 in a direction different from a lens optical axis direction of the virtual projection apparatus 202. Then, the information processing apparatus 50 changes the position of the virtual projection apparatus 202 based on the disposition change data described above, but maintains the position of the virtual projection surface 204. That is, the projection center point P2 of the virtual projection surface 204 is not moved, and the information processing apparatus 50 changes a lens shift parameter related to the lens shift of the virtual projection apparatus 202. The lens shift parameter is a parameter of the shift of a projection position of the virtual projection apparatus 202. The change in the lens shift parameter corresponds to a distance D1 in FIG. 19. The distance D1 corresponds to a distance between a projection center point P3 of the virtual projection apparatus 202 after the movement and the projection center point P2 of the virtual projection surface 204 in the initial state under a condition in which the parameter is not changed.

The information processing apparatus 50 outputs the second image data of the virtual projection apparatus 202 of which the disposition is changed to the touch panel 51 that is the display device as the output destination, and the touch panel 51 also displays the second image based on the second image data together with the first image (space image 70). The output of the second image data and the display of the second image as described above are common to all the examples described below. As a result, the user can easily and intuitively understand a relationship between the virtual projection apparatus 202 and the virtual projection surface 204, and can easily and intentionally adjust the position of the virtual projection apparatus 202.

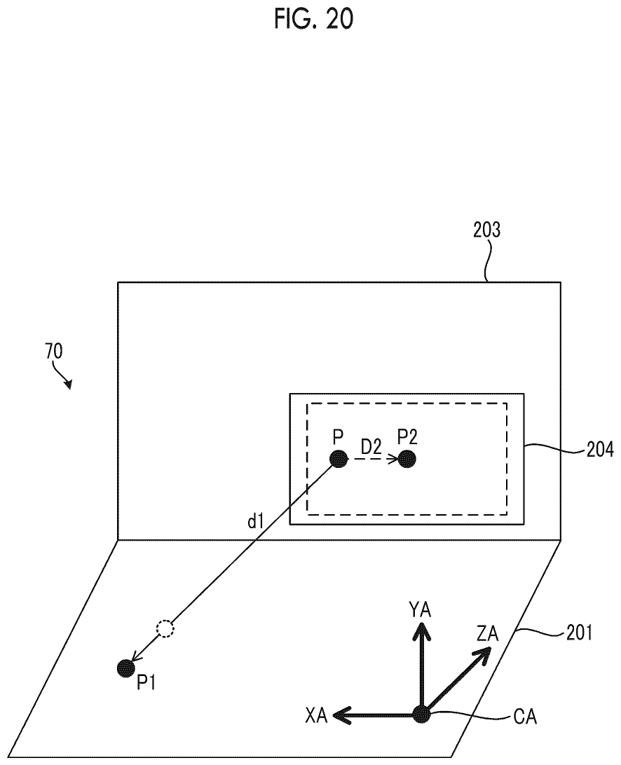

FIG. 20 is a diagram illustrating movement of the virtual projection apparatus 202 in the rear direction, that is, movement in a ZA axis negative direction. The user can instruct the information processing apparatus 50 to perform such movement by pressing a rear button of the front/rear/left/right movement button B15. Movement of the virtual projection apparatus 202 in the front direction, that is, movement in a ZA axis positive direction can be indicated by pressing a front button of the front/rear/left/right movement button B15.

In this case, the information processing apparatus 50 changes the position of the virtual projection apparatus 202 in the lens optical axis direction of the virtual projection apparatus 202. Then, the information processing apparatus 50 changes the position of the virtual projection apparatus 202 based on the disposition change data described above, but maintains the position of the virtual projection surface 204. That is, the projection center point P2 of the virtual projection surface 204 is not moved, and the information processing apparatus 50 changes the lens shift parameter related to the lens shift of the virtual projection apparatus 202.

Meanwhile, the information processing apparatus 50 enlarges the size of the virtual projection surface 204. A broken line in FIG. 20 is the virtual projection surface 204 before enlargement. In a case where the virtual projection apparatus 202 is moved in the front direction, the size of the virtual projection surface 204 is reduced. That is, the information processing apparatus 50 changes the size of the virtual projection surface 204 according to a projection distance d1 from the virtual projection apparatus 202 to the virtual projection surface 204. As a result, the user can easily and intuitively understand the relationship between the virtual projection apparatus 202 and the virtual projection surface 204, and can easily and intentionally adjust the position of the virtual projection apparatus 202.

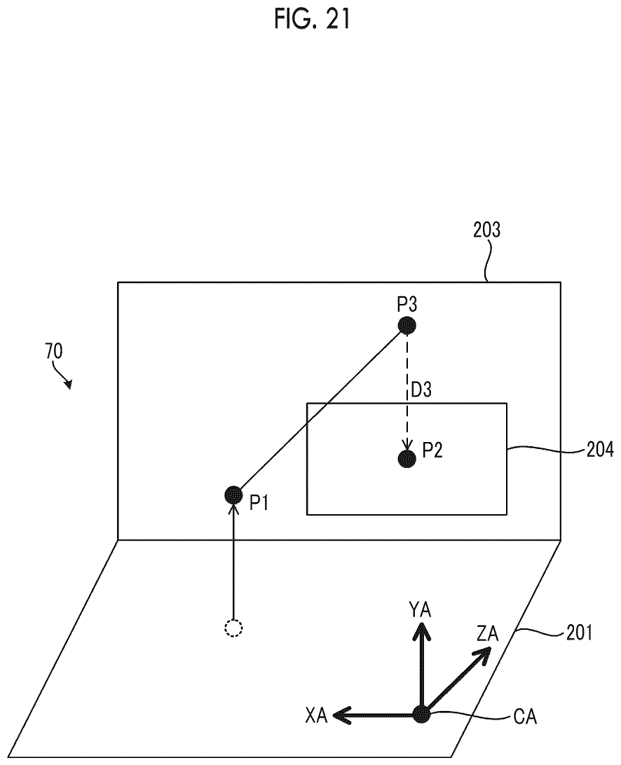

FIG. 21 is a diagram illustrating movement of the virtual projection apparatus 202 in the upward direction, that is, movement in a YA axis positive direction. The user can instruct the information processing apparatus 50 to perform such movement by pressing an up button of the up/down movement button B14 (FIGS. 12A and 12B). Movement of the virtual projection apparatus 202 in a downward direction, that is, movement in a YA axis negative direction can be indicated by pressing a down button of the up/down movement button B14.

In this case, the information processing apparatus 50 changes the position of the virtual projection apparatus 202 in a direction different from the lens optical axis direction of the virtual projection apparatus 202. Then, the information processing apparatus 50 changes the position of the virtual projection apparatus 202 based on the disposition change data described above, but maintains the position of the virtual projection surface 204. That is, the projection center point P2 of the virtual projection surface 204 is not moved, and the information processing apparatus 50 changes the lens shift parameter related to the lens shift of the virtual projection apparatus 202. The change in the lens shift parameter corresponds to a distance D3 in FIG. 21. The distance D3 corresponds to a distance between the projection center point P3 of the virtual projection apparatus 202 after the movement and the projection center point P2 of the virtual projection surface 204 in the initial state under a condition in which the parameter is not changed.

As a result, the user can easily and intuitively understand the relationship between the virtual projection apparatus 202 and the virtual projection surface 204, and can easily and intentionally adjust the position of the virtual projection apparatus 202.

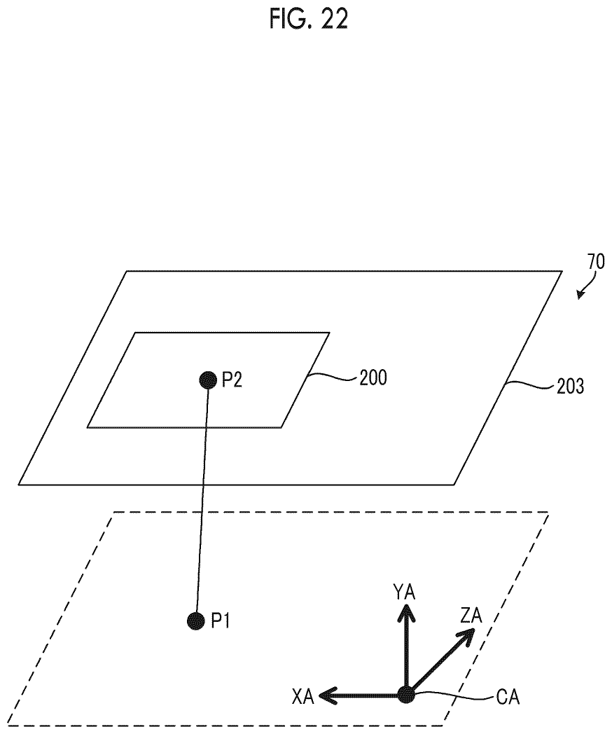

FIG. 22 is a simulation diagram in the initial state in the virtual projection apparatus priority mode, as in FIG. 18. The coordinates of the virtual projection apparatus 202 conform to the projection apparatus coordinate system CA described with reference to FIG. 8, and the projection direction changing mechanism 104 (FIG. 4) disposes the second member 103 such that the second member 103 is directed in the direction parallel to the projection apparatus installation virtual surface 201. Even in this case, the information processing apparatus 50 controls the virtual projection apparatus 202 and the virtual projection surface 204 in response to the instruction of the user, as in FIGS. 18 to 21.

It should be noted that the information processing apparatus 50 can also rotate the virtual projection apparatus 202 about an axis in the lens optical axis direction of the virtual projection apparatus 202, that is, can change the direction, based on the disposition change data. In this case, the information processing apparatus 50 rotates the virtual projection surface 204 in accordance with the rotation of the virtual projection apparatus 202 (change in direction).

### <Movement of Virtual Projection Surface 204 in Virtual Projection Apparatus Priority Mode>

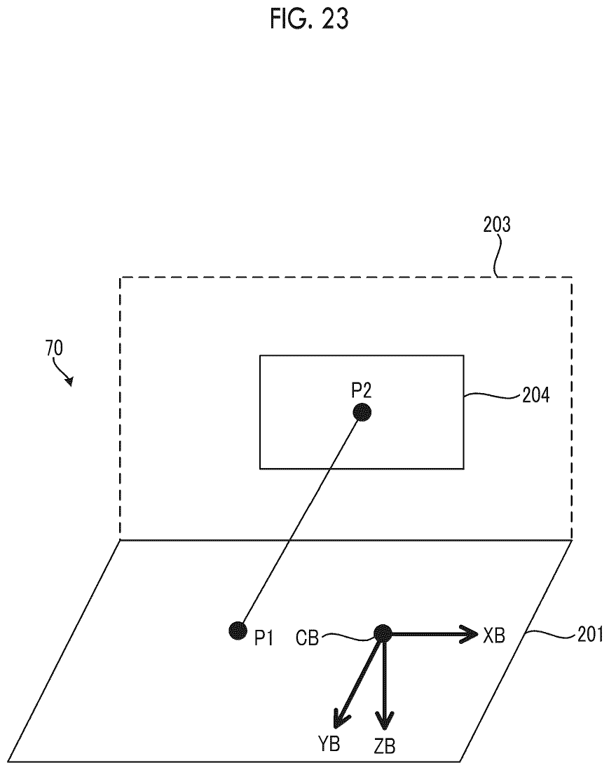

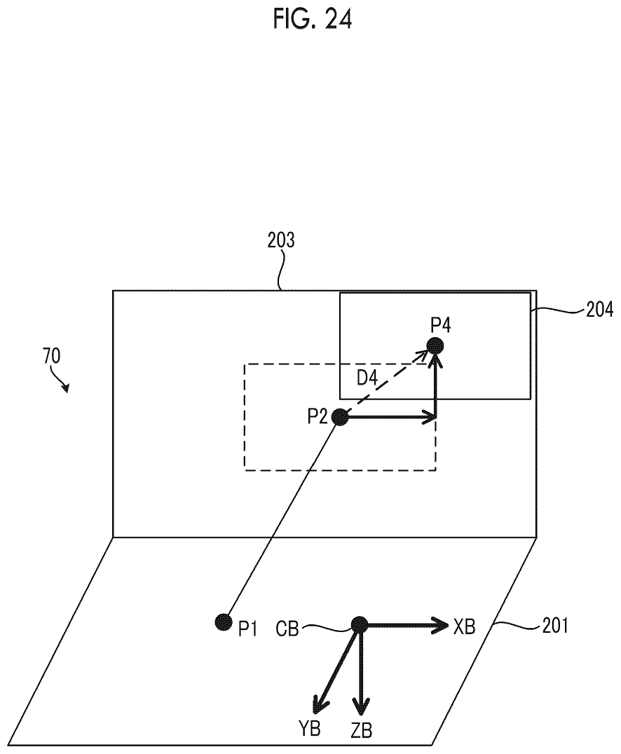

FIGS. 23 and 24 are simulation diagrams of an example in which the user gives an instruction to move the virtual projection surface 204, that is, to change the position of the virtual projection surface 204, in the virtual projection apparatus priority mode.

FIG. 23 is a simulation diagram in the initial state in the virtual projection apparatus priority mode, as in FIG. 18. The coordinates of the virtual projection surface 204 conform to the projection surface coordinate system CB described with reference to FIG. 9. As described above, the projection surface coordinate system CB includes the XB axis along the shift direction in the horizontal direction of the projection range 11, the ZB axis along the shift direction in the vertical direction of the projection range 11, and the YB axis perpendicular to the projection surface installation virtual surface 203, which are used by the shift mechanism 105. The point P1 is the lens center point of the virtual projection apparatus 202, and the point P2 is the projection center point of the virtual projection surface 204 without the lens shift.

The user operates any one of the user interfaces 64 shown in FIGS. 11 to 17, whereby the virtual projection surface 204 is moved in the space image 70 (first image).

The user can change the position of the virtual projection surface 204 by, for example, pressing the up/down/left/right movement button B25 (FIG. 11). FIG. 24 is a diagram illustrating movement of the virtual projection surface 204 in the right direction and the upward direction, that is, movement in a XB axis positive direction and movement in a ZB axis negative direction. The user can instruct the information processing apparatus 50 to perform such movement by pressing a right button and an up button of the up/down/left/right movement button B25. Movement of the virtual projection surface 204 in the left direction, that is, movement in an XB axis negative direction can be indicated by pressing a left button of the up/down/left/right movement button B25. Movement of the virtual projection surface 204 in the upward direction, that is, movement in the ZB axis negative direction can be indicated by pressing the up button of the up/down/left/right movement button B25. Movement of the virtual projection surface 204 in the downward direction, that is, movement in a ZB axis positive direction can be indicated by pressing a down button of the up/down/left/right movement button B25.

In this case, the information processing apparatus 50 changes the position of the virtual projection surface 204 based on the disposition change data described above, but maintains the position of the virtual projection apparatus 202. That is, the projection center point P2 of the virtual projection surface 204 is moved, and the information processing apparatus 50 changes the lens shift parameter related to the lens shift of the virtual projection apparatus 202. The change in the lens shift parameter corresponds to a distance D4 in FIG. 24. The distance D4 corresponds to a distance between a projection center point P4 of the virtual projection surface 204 after the movement and the projection center point P2 of the virtual projection surface 204 in the initial state. As a result, the user can easily and intuitively understand the relationship between the virtual projection apparatus 202 and the virtual projection surface 204, and can easily and intentionally adjust the position of the virtual projection surface 204.

It should be noted that the information processing apparatus 50 can also rotate the virtual projection surface 204 about an axis in a direction orthogonal to the virtual projection surface 204, that is, can change the direction, based on the disposition change data. In this case, the virtual projection apparatus 202 is rotated in accordance with the rotation of the virtual projection surface 204 (change in direction).

### <Installation Posture Determination of Virtual Projection Apparatus 202>

In the examples described so far, the projection apparatus 10 takes an installation posture in which the projection apparatus 10 is installed on the floor surface, and the virtual projection apparatus 202 is used by being installed on the projection apparatus installation virtual surface 201 assuming the floor surface. However, the projection apparatus 10 is used not only on the floor surface but also in a state of being suspended from a ceiling surface. The projection apparatus coordinate system CA in FIGS. 7 and 8 is exclusively intended for the use of a floor surface disposition, and it is preferable to use another coordinate system in a case of being suspended from a ceiling for use.

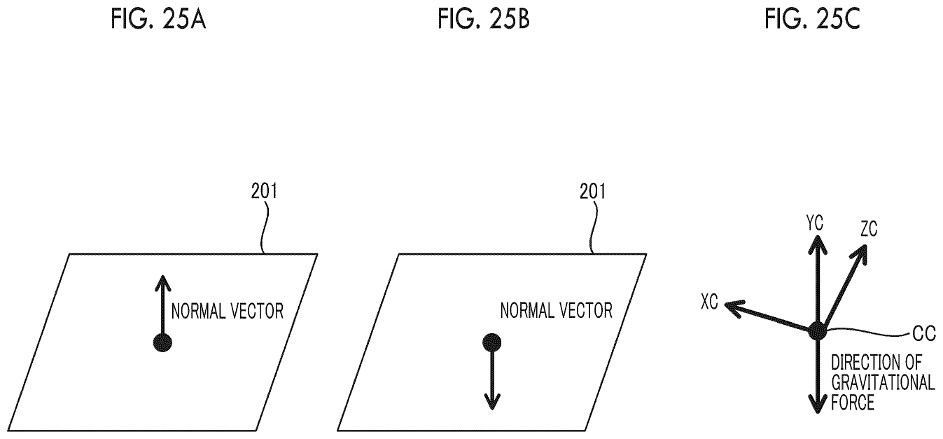

FIGS. 25A to 25C are diagrams illustrating a normal vector corresponding to an installation posture of the virtual projection apparatus 202 and a spatial coordinate system CC. While the projection apparatus coordinate system CA and the projection surface coordinate system CB are local coordinate systems, the spatial coordinate system CC is a world coordinate system. FIG. 25A shows a normal vector corresponding to an installation posture of the virtual projection apparatus 202 in a case where the projection apparatus 10 is installed on the floor surface and the projection apparatus installation virtual surface 201 is the floor surface. In a case where a Y-axis component of the normal vector of the projection apparatus installation virtual surface 201 is 0.9 or more, the information processing apparatus 50 determines that the projection apparatus installation virtual surface 201 is on the floor surface.

FIG. 25B shows a normal vector corresponding to an installation posture of the virtual projection apparatus 202 in a case where the projection apparatus 10 is suspended from the ceiling and the projection apparatus installation virtual surface 201 is the ceiling surface. In a case where the Y-axis component of the projection apparatus installation virtual surface 201 is −0.9 or less, the information processing apparatus 50 determines that the projection apparatus installation virtual surface 201 is on the ceiling surface.

That is, the information processing apparatus 50 can extract the installation postures based on the installation position of the virtual projection apparatus 202 in the space from among installation posture candidates of the virtual projection apparatus 202.

In the spatial coordinate system CC, the YA axis of the projection apparatus coordinate system CA of FIGS. 7 and 8 is a direction of gravitational force, and the Y-axis component is set to be a YC axis that is opposite to the YA axis (opposite to the direction of gravitational force). That is, the information processing apparatus 50 can reflect the installation posture of the virtual projection apparatus 202 selected from among the extracted installation postures of the virtual projection apparatus 202 in the second image. As a result, the information processing apparatus 50 can set an appropriate coordinate system according to the installation posture of the virtual projection apparatus 202.

The information processing apparatus 50 may detect an installation state by itself and determine whether the projection apparatus installation virtual surface 201 is on the floor surface or the ceiling surface. In addition, the information processing apparatus 50 may determine whether the projection apparatus installation virtual surface 201 is on the floor surface or the ceiling surface by the user operating a predetermined operating part for selecting the floor placement or the ceiling suspension.

FIG. 26 is a diagram of an image displayed on the touch panel 51 and showing a state in which the virtual projection apparatus 202 is installed on the floor surface, and FIG. 27 is a diagram of an image displayed on the touch panel 51 and showing a state in which the virtual projection apparatus 202 is suspended from the ceiling surface. In any screen, a list L showing the installation postures of the virtual projection apparatus 202 is displayed, and the user can select the current installation posture.

As a result, the user can easily and intuitively understand a relationship between the installation posture of the virtual projection apparatus 202 and the projection range, and can easily select an optimal installation posture. In a case where a rotation angle of the virtual projection apparatus 202 is already set by the rotation operation, the rotation angle may or may not be maintained.

### <Restriction on Lens Shift of Virtual Projection Apparatus 202>

There is a possibility that an event occurs in which a shift range (specification range) of the projection position of the projection apparatus 10, which is an actual machine, is exceeded by the user attempting to excessively perform the lens shift of the virtual projection apparatus 202. In such a case, it is desirable that the information processing apparatus 50 notifies the user of the fact.

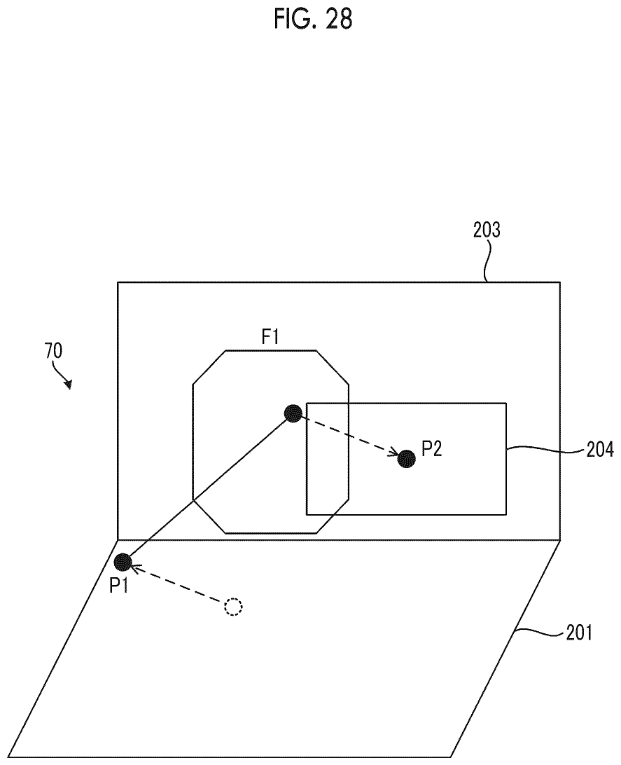

FIG. 28 is a diagram showing a state in which a shift range in which the lens shift of the projection position of the virtual projection apparatus 202 is possible is displayed on the second image of the virtual projection apparatus 202. The information processing apparatus 50 displays a shift range F1 by using a polygonal frame line. As a result, the user can know that the shift range of the virtual projection apparatus 202 is limited. The information processing apparatus 50 can perform control of switching between a state in which the shift range F1 is displayed on the second image and a state in which the shift range F1 is not displayed on the second image. In addition, a display aspect of the shift range is not limited to the shift range F1 indicated by the polygonal frame line, and may be a dialog, a sound notification, or the like, and is not particularly limited.

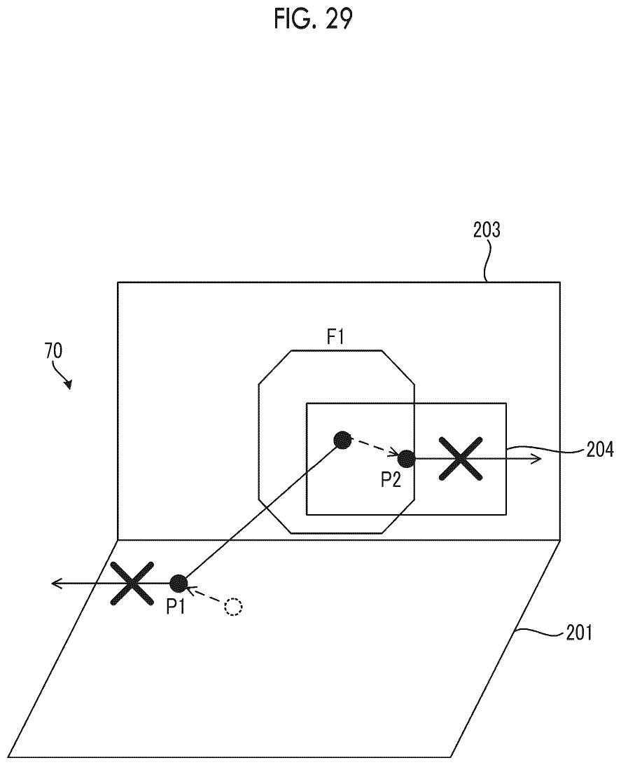

FIG. 29 is a diagram showing a state in which the information processing apparatus 50 clips the lens shift of the projection position of the virtual projection apparatus 202 at an end of the shift range F1 to restrict movement beyond the range. The user moves the lens center point P1 of the virtual projection apparatus 202 and attempts to move the projection position outside the shift range F1. The information processing apparatus 50 clips the projection position moved by the user, and notifies the user that such a position change, that is, setting the projection position outside the shift range F1 is impossible, by using a symbol such as “x”.

As a result, the user can specify the lens shift of the projection position of the virtual projection apparatus 202 after understanding the shift range that can be set in the actual machine. In particular, in a case where the projection position is clipped at the end of the shift range, it is possible to facilitate setting of the virtual projection apparatus 202 or the virtual projection surface 204 at an upper limit value of the lens shift. In addition, in a case where the movement outside the shift range is allowed, the virtual projection surface 204 can be moved to a desired location in advance, and then the position of the virtual projection apparatus 202 can be adjusted such that the virtual projection surface 204 is within the shift range. According to the present processing, flexible position setting as described above is possible.

### <Movement of Virtual Projection Surface 204 in Virtual Projection Surface Priority Mode>

FIGS. 30 to 33 are simulation diagrams of an example in which the user gives an instruction to move the virtual projection surface 204, that is, to change the position of the virtual projection surface 204 in the virtual projection surface priority mode. The user operates any one of the buttons shown in FIGS. 11 to 17 to move the virtual projection surface 204. Here, in a case where a scene in which the position of the virtual projection apparatus 202 is not fixed (non-fixed) is assumed, the user can freely move the virtual projection surface 204 without being conscious of the position of the virtual projection apparatus 202. On the other hand, in a case where a scene in which the position of the virtual projection apparatus 202 is fixed is assumed, the user can concentrate on the adjustment of the position of the virtual projection surface 204 after the position of the virtual projection apparatus 202 is specified in advance.

FIG. 30 is a simulation diagram of an initial state in the virtual projection surface priority mode and in a case where the position of the virtual projection apparatus 202 is not fixed. Although the position of the virtual projection apparatus 202 is not fixed, the installable range of the virtual projection apparatus 202 is limited. Therefore, the information processing apparatus 50 displays an installable range F2 of the virtual projection apparatus 202 by using a frame line. That is, the installable range F2 is a type of the second image, and is an image displaying an installable range in which the virtual projection apparatus 202 is installable.

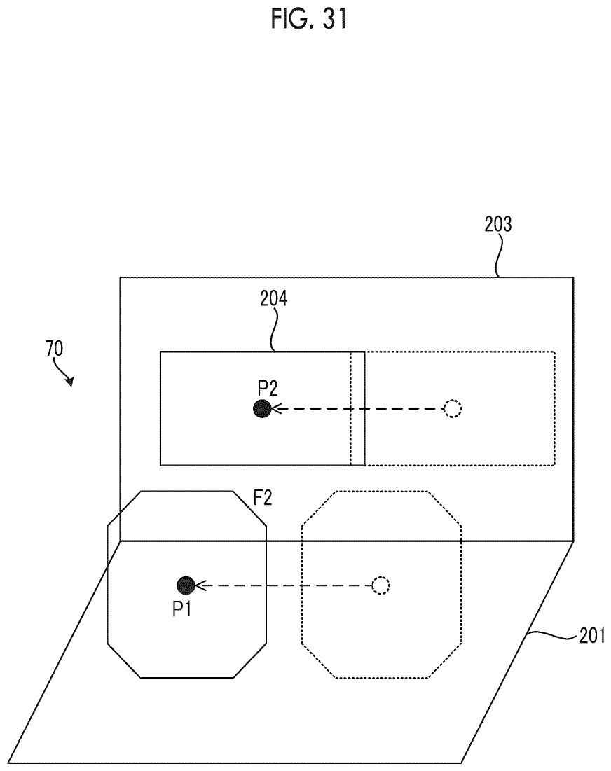

The user can change the position of the virtual projection surface 204 by, for example, pressing the up/down/left/right movement button B25 (FIG. 11). FIG. 31 is a diagram illustrating the movement of the virtual projection surface 204 in the left direction, that is, the movement in the XB axis negative direction. The user can instruct the information processing apparatus 50 to perform such movement by pressing the left button of the up/down/left/right movement button B25. The virtual projection surface 204 can also be moved in another direction by the similar operation. In this case, the virtual projection surface 204, the virtual projection apparatus 202, and the installable range F2 move as a whole.

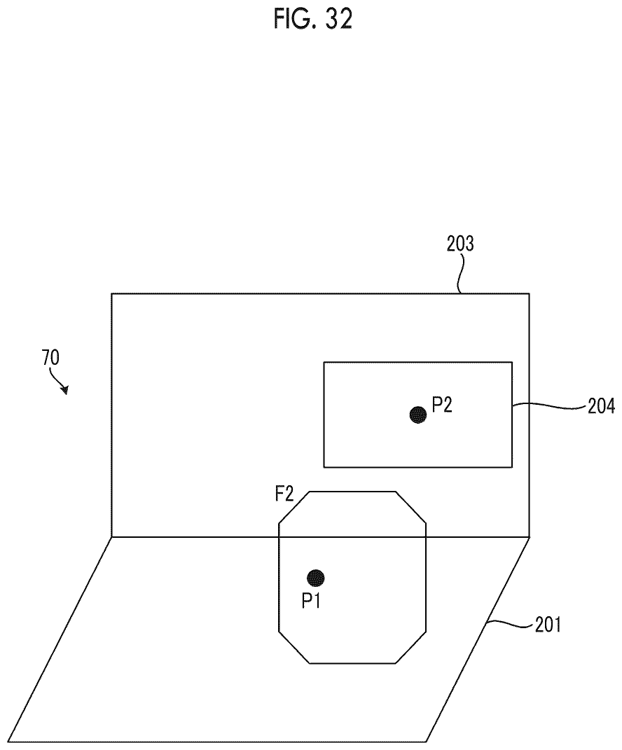

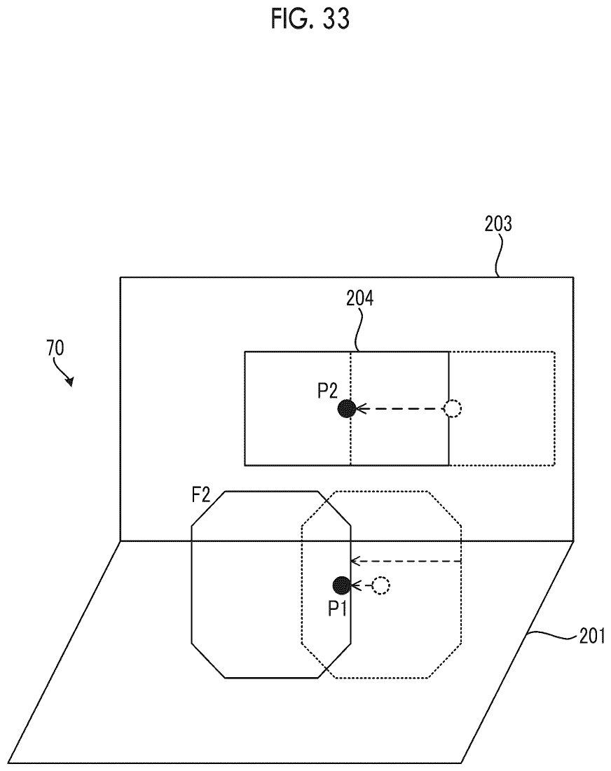

FIG. 32 is a simulation diagram of an initial state in the virtual projection surface priority mode and in a case where the position of the virtual projection apparatus 202 is fixed. As shown in FIG. 33, the user can move the virtual projection surface 204 in the left direction by the similar operation with the operation described with reference to FIG. 31.

In this case, the virtual projection surface 204 and the installable range F2 move together. On the other hand, the position of the virtual projection apparatus 202 is fixed, and the virtual projection apparatus 202 does not move. In this case, the information processing apparatus 50 changes the position of the installable range F2 based on the change in the position of the virtual projection surface 204, that is, the disposition change data of the virtual projection surface 204.

### <Size Change of Virtual Projection Surface 204 in Virtual Projection Surface Priority Mode>

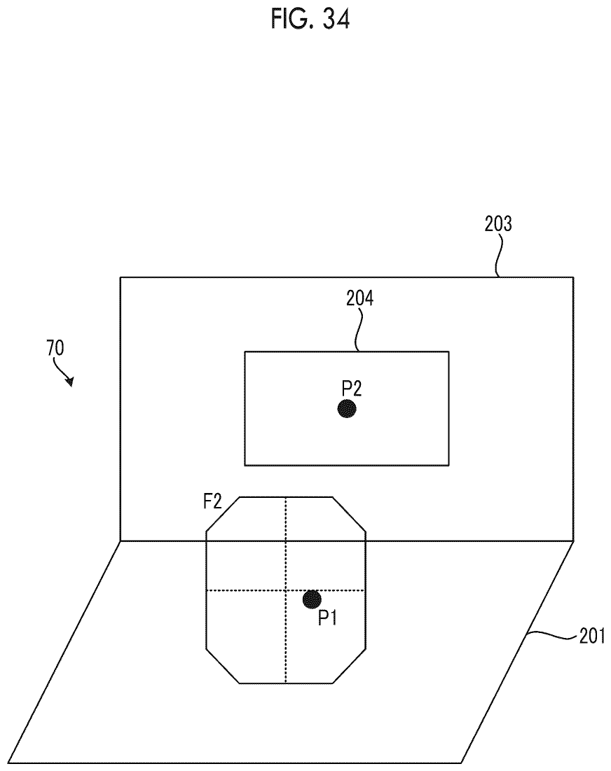

FIGS. 34 to 37 are simulation diagrams of an example in which the user gives an instruction to change the size of the virtual projection surface 204 in the virtual projection surface priority mode. The user can change the size of the virtual projection surface 204 with, for example, a pinch gesture of tracing the touch panel 51 as shown in FIG. 17. By changing the size of the virtual projection surface 204, the size of the installable range F2 of the virtual projection apparatus 202 and the distance from the virtual projection apparatus 202 to the virtual projection surface 204 are changed. As a result, the user can visually understand a relationship between the virtual projection surface 204 and the installable range F2. In a case where the position of the virtual projection apparatus 202 is not fixed, it is convenient in a case where the installation is desired to be performed at an upper limit value of the lens shift parameter. In a case where the position of the virtual projection apparatus 202 is fixed, it is convenient in a case where the movement only in the projection direction is desired, such as a case where it is decided to install the virtual projection apparatus 202 on the ceiling.

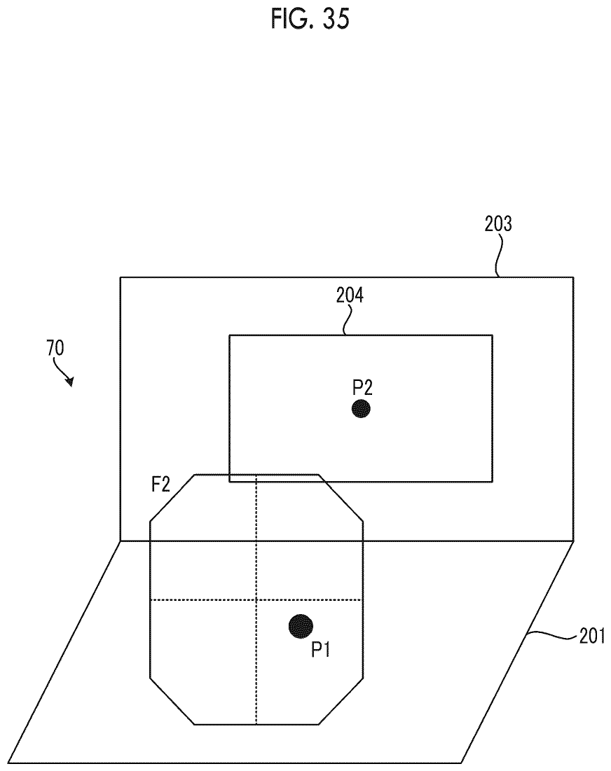

FIG. 34 is a simulation diagram of an initial state in the virtual projection surface priority mode and in a case where the position of the virtual projection apparatus 202 is not fixed. The user can enlarge the virtual projection surface 204 (for example, enlarge the virtual projection surface 204 by 20% in the left-right direction and 10% in the up-down direction) as shown in FIG. 35 by, for example, tracing the touch panel 51 with a pinch gesture, and the installable range F2 is also enlarged in conjunction with the enlargement. The same applies to the reduction of the virtual projection surface 204. That is, in a case where the size of the virtual projection surface 204 is changed based on the disposition change data, the information processing apparatus 50 changes the position and/or the size of the installable range F2 in accordance with the change in the size of the virtual projection surface 204. In this case, the relative position with respect to the installable range F2 of the virtual projection apparatus 202 does not change, and the lens shift parameter also does not change.

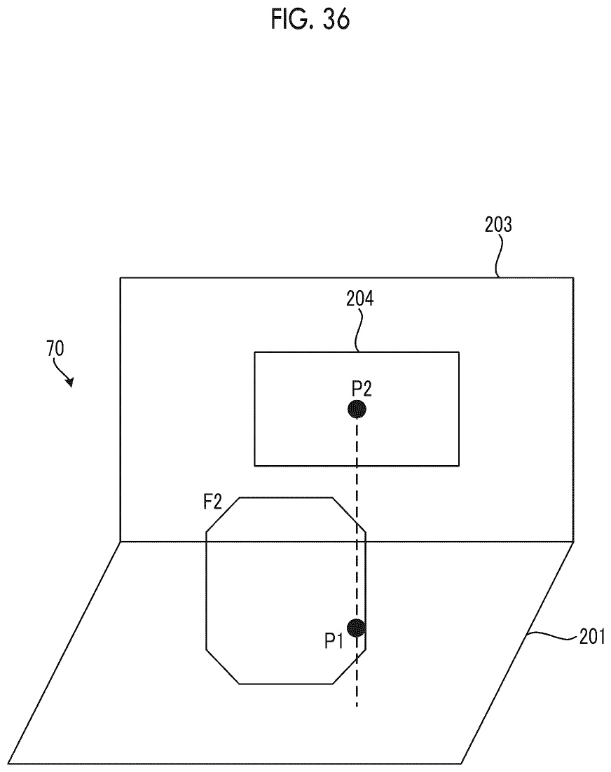

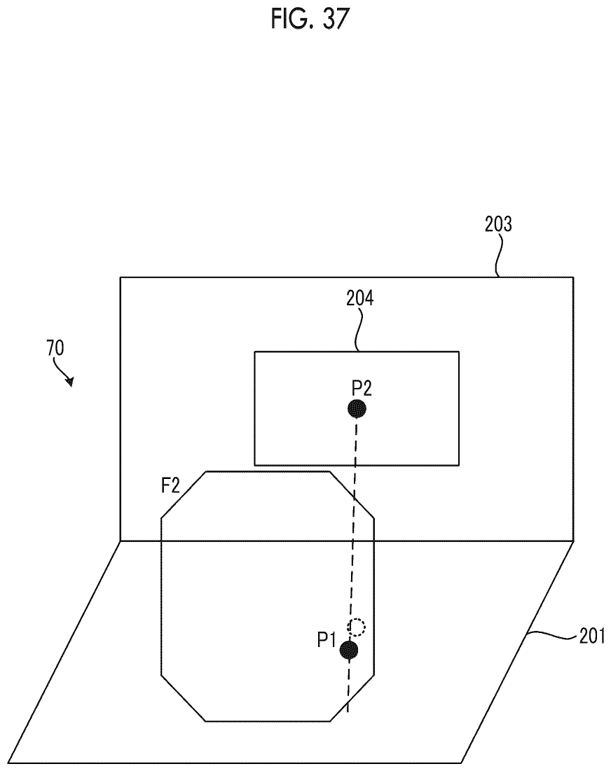

FIG. 36 is a simulation diagram of an initial state in the virtual projection surface priority mode and in a case where the position of the virtual projection apparatus 202 is fixed. As shown in FIG. 37, the user can change the size of the virtual projection surface 204 via the similar operation with the operation described with reference to FIG. 35. In this case, the position of the virtual projection apparatus 202 is moved only in the projection direction, and the lens shift parameter is changed.

Even in the virtual projection surface priority mode, in a case where the position of the virtual projection apparatus 202 is not fixed, the information processing apparatus 50 can change the position of the virtual projection apparatus 202 based on the disposition change data. In this case, the information processing apparatus 50 changes the position of the virtual projection apparatus 202 within the installable range F2.

Even in the virtual projection surface priority mode, the information processing apparatus 50 may display all the installation postures of the virtual projection apparatus 202, or may select and display any one of the floor installation posture or the ceiling installation posture according to the operation of the user. In a case where the installation posture is changed, the information processing apparatus 50 changes the orientation of the virtual projection surface 204 and the orientation of the installable range F2, corresponding to the new posture.

That is, the information processing apparatus 50 can also rotate the virtual projection surface 204, that is, can change the direction, based on the disposition change data. In this case, the installable range F2 is rotated in accordance with the rotation of the virtual projection surface 204 (change in direction).

In this case, the position of the virtual projection apparatus 202 may be non-fixed or fixed. However, in a case of being fixed, the position of the virtual projection apparatus 202 may be out of the installable range F2 because of the rotation of the installable range F2. In this case, the lens shift parameter is set to a position in a case where the clipping is performed, so that the position of the virtual projection apparatus 202 is at an end of the installable range F2. As a result, the user can easily and intuitively understand a relationship between the installation posture of the virtual projection apparatus 202 and the virtual projection surface 204, and can easily select an optimal installation posture.

### <Common Items Between Virtual Projection Apparatus Priority Mode and Virtual Projection Surface Priority Mode>

Hereinafter, common items between the virtual projection apparatus priority mode and the virtual projection surface priority mode will be described.

The user can rotate the virtual projection apparatus 202 or the virtual projection surface 204 by pressing the rotation button B13 of FIG. 12A or the projection surface rotation button B24 of FIG. 12B. The virtual projection apparatus 202 rotates about the Z axis, and the virtual projection surface 204 rotates about the Y axis. In a case of the virtual projection surface priority mode, the installable range of the virtual projection apparatus 202 also rotates. As a result, the user can install the virtual projection apparatus 202 and the virtual projection surface 204 at a desired angle.

The user can change the aspect ratio of the virtual projection surface 204 by pressing the aspect ratio change button B21 of FIG. 12B. In this case, cropping may be performed, or the position (and the installable range) of the virtual projection apparatus 202 may be changed to maintain the length (size in inches) of a diagonal line of the virtual projection surface 204. As a result, the user can set the position of the virtual projection apparatus 202 and the virtual projection surface 204 to implement a desired aspect ratio. In association with the change in the aspect ratio, the length of the diagonal line of the virtual projection surface 204 can also be changed. In addition, in association with the change in the aspect ratio, the information processing apparatus 50 may change the distance between the virtual projection surface 204 and the virtual projection apparatus 202.

The user can display an image or a video selected on the virtual projection surface 204 by pressing the image setting button B22 of FIG. 12B. That is, the image of the virtual projection surface 204 to be superimposed on the second image is an image selected by the user. As a result, the user can understand the situation in which the desired image or video is projected.

The user can rotate the image of the virtual projection surface 204 being displayed by pressing the image rotation button B23 of FIG. 12B. In addition, the user can perform the enlargement or the reduction of the virtual projection surface 204 by the pinch gesture described with reference to FIGS. 13A to 17.

The user can operate a predetermined operating part to display the parameter of the virtual projection apparatus 202 currently set. That is, the information processing apparatus 50 can perform control of displaying, on the display device, the projection parameter of the virtual projection apparatus 202 corresponding to the disposition of the virtual projection surface 204 and the virtual projection apparatus 202 represented by the second image. The information processing apparatus 50 may display the projection parameter in a region different from the second image or in another apparatus, or may insert the information in the second image. As a result, the user can understand the parameter of the virtual projection apparatus 202 in a numerical value, and can use the parameter for more detailed design, such as a review on a drawing.

The projection parameter includes, for example, a projection distance, a lens shift value (which may be displayed in terms of a distance), a distance to each installation virtual surface, a position or a direction of each object in a reference coordinate system set by the user.

In addition, in a case where a plurality of combinations of the virtual projection surface 204 and the virtual projection apparatus 202 are present, the information processing apparatus 50 can also perform control of setting a combination selected from among the plurality of combinations by the user operation as a disposition change target. As a result, the convenience for the user is improved.

### <Display of Boundary of Projection Light>

The information processing apparatus 50 may display, by some method, a boundary between a space through which the projection light projected from the virtual projection apparatus 202 is estimated to pass and a space through which the projection light is estimated not to pass, between the lens center point P1 of the virtual projection apparatus 202 and the projection center point P2 of the virtual projection surface 204.

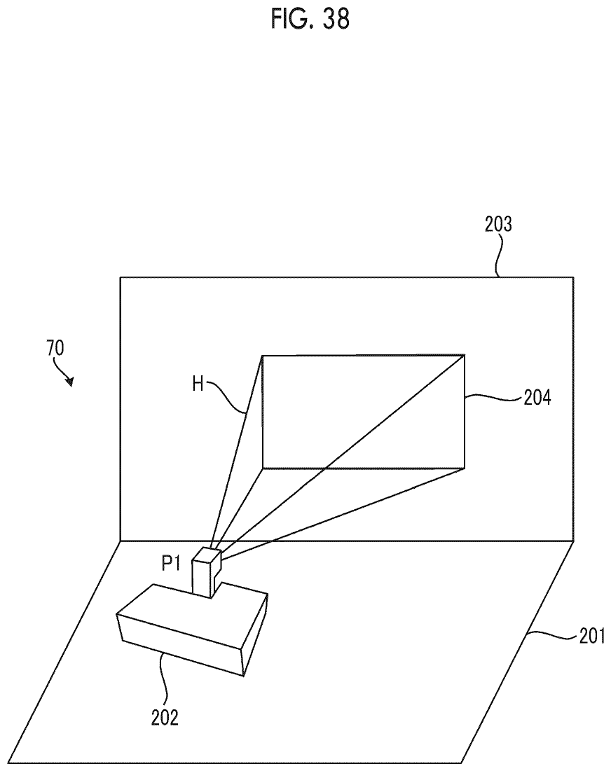

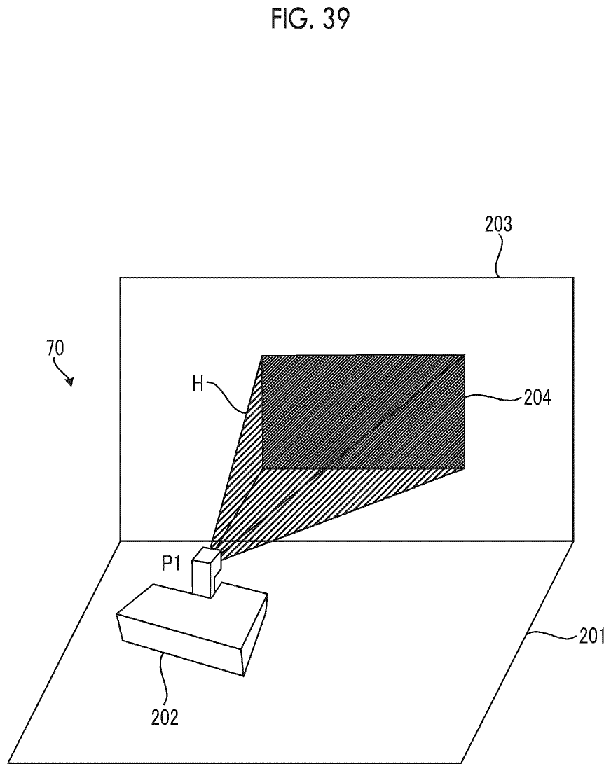

FIG. 38 is an example of a display method of a boundary H, and the boundary H is expressed by a line connecting four corners of the virtual projection surface 204 and the lens center point P1, and the space through which the projection light is estimated to pass is defined. FIG. 39 is another example of the display method of the boundary, and the space through which the projection light is estimated to pass and the boundary are defined by a combination of triangles having one side of the virtual projection surface 204 as a base side and the lens center point P1 as a vertex.

In the present example, the second image is an image representing the boundary of the projection light from the virtual projection apparatus 202 to the virtual projection surface 204. As a result, the user can understand the boundary through which the projection light passes, and can review the installation position of the virtual projection apparatus 202 in consideration of a standing position of the observer, whether or not other devices block the projection light, and the like.

### <Installation Assist>

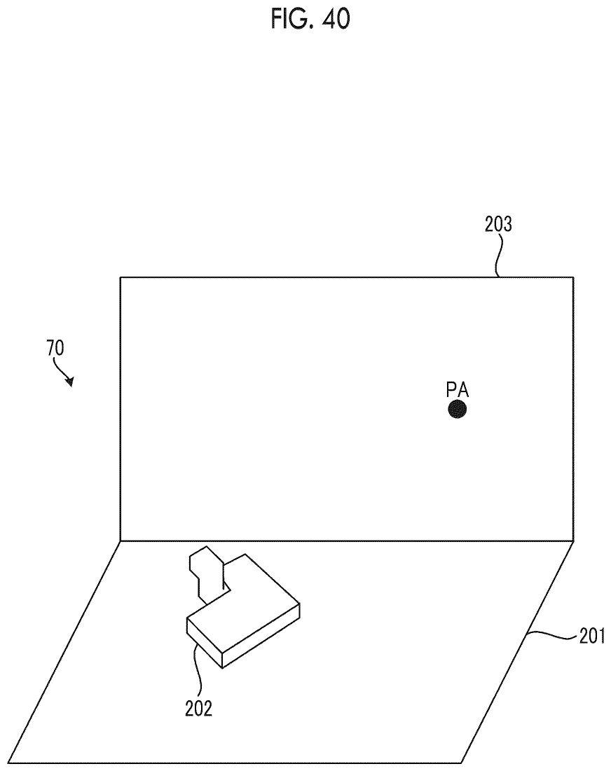

In a case of the virtual projection apparatus 202 in which the position of the virtual projection surface 204 can be moved by the lens shift, it is necessary to specify three points, that is, the position of the virtual projection apparatus 202, the projection center point of the virtual projection apparatus 202 without the lens shift, and the projection center point of the virtual projection apparatus 202 due to the lens shift, in order to confirm the size and the position of the virtual projection surface 204. On the other hand, the user's interest is solely in two points, that is, the position of the virtual projection apparatus 202 and the projection center point due to the lens shift. Therefore, in a case where the size and the position of the virtual projection surface 204 can be confirmed only by the designation of the two points of interest, the user's effort can be reduced. FIGS. 40 to 42 are diagrams for describing a method of assisting the installation of the virtual projection apparatus 202 based on such an idea in the virtual projection apparatus priority mode.

FIG. 40 is a diagram showing a first step of the installation assist. The information processing apparatus 50 acquires the disposition change data related to the disposition change of the virtual projection apparatus 202. The disposition change data here includes data for giving an instruction to change the position of the virtual projection apparatus 202 and a first projection center PA of the virtual projection apparatus 202 on the virtual projection surface 204 due to the shift of the projection position of the virtual projection apparatus 202. The first projection center PA is a projection center point finally desired by the user.

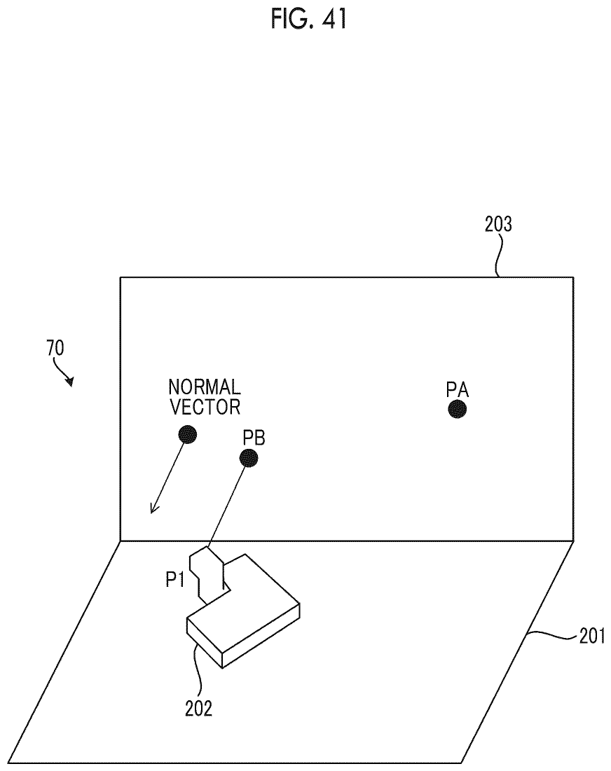

FIG. 41 is a diagram showing a second step of the installation assist. The information processing apparatus 50 sets a second projection center PB, which is a projection center point without the lens shift, at a point at which a straight line parallel to a normal vector of the projection surface installation virtual surface 203 intersects the projection surface installation virtual surface 203 in a case where the straight line is extended from the lens center point P1 of the virtual projection apparatus 202.

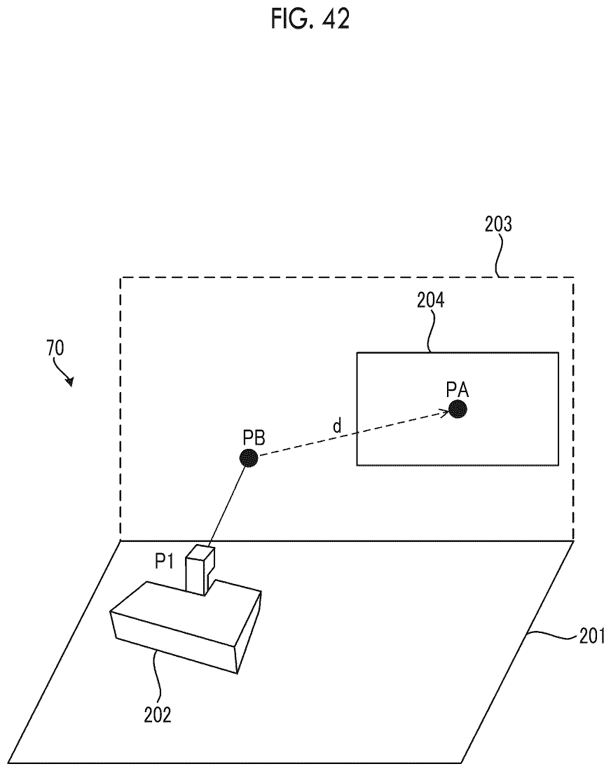

FIG. 42 is a diagram showing a third step of the installation assist. The information processing apparatus 50 changes the size of the virtual projection surface 204 based on the second projection center PB. Specifically, the information processing apparatus 50 calculates a projection distance d, which is a distance between the lens center point P1 and the second projection center PB, and specifies the size of the virtual projection surface 204. Further, the information processing apparatus 50 specifies the lens shift amount from the positions of the first projection center PA and the second projection center PB, and the size of the virtual projection surface 204. Then, the information processing apparatus 50 changes the direction of the position of the virtual projection apparatus 202 such that the position is directed toward the second projection center PB.

In the virtual projection surface priority mode, the information processing apparatus 50 can specify an installation candidate range of the virtual projection apparatus 202 by specifying the projection center and the size of the virtual projection surface 204. The information processing apparatus 50 can reduce a burden on the user in the subsequent adjustment by appropriately specifying the initial position of the virtual projection apparatus 202 on the installation candidate range.

In a case where the position of the virtual projection apparatus 202 is specified in the installable range F2, the information processing apparatus 50 may set the position in a case where the lens shift is not performed at the zoom 100% as the position of the virtual projection apparatus 202. The position of the virtual projection apparatus 202 may be set based on an intersection between a line extending from a point where the user taps the touch panel 51 in a normal direction of the imaging surface and the installation candidate range. In addition, the position of the virtual projection apparatus 202 may be set based on an intersection between a line extending from a camera center point in the normal direction of the imaging surface in a case where the user presses an installation button, and the installation candidate range.

It should be noted that the information processing apparatus 50 can also be configured to change the size of the virtual projection surface 204 by using a general zoom function (optical zoom, digital zoom, and the like).

Each of the embodiments and the modification examples described above can be implemented in combination with each other.

At least the following items are disclosed in the present specification.

(1)

An information processing apparatus comprising a processor,
in which the processor is configured to:
   acquire first image data representing a first image obtained by imaging with an imaging device;
   acquire disposition data related to a disposition of a virtual projection surface and a virtual projection apparatus in a space indicated by the first image;
   acquire disposition change data related to a disposition change of the virtual projection surface and/or the virtual projection apparatus in the first image;
   generate second image data representing a second image in which the virtual projection surface and/or the virtual projection apparatus of which the disposition is changed based on the disposition change data is displayed on the first image; and
   output the second image data to an output destination.
      (2)

The information processing apparatus according to (1),
in which the disposition change data includes data for giving an instruction to change at least any one of a position of the virtual projection surface and/or the virtual projection apparatus, a direction of the virtual projection surface and/or the virtual projection apparatus, or a size of the virtual projection surface.
   (3)

The information processing apparatus according to (1) or (2), further comprising:
a display device,
in which the output destination is the display device.
   (4)

The information processing apparatus according to any one of (1) to (3), further comprising:
the imaging device.
   (5)

The information processing apparatus according to any one of (1) to (4), further comprising:
an input receiver that receives input of the disposition change data from a user.
   (6)

The information processing apparatus according to (5),
in which the processor is configured to perform, in a case where the input of the disposition change data is received from the user, control of displaying, on a display device, an image including an operation image for giving an instruction to perform the disposition change of the virtual projection surface and an operation image for giving an instruction to perform the disposition change of the virtual projection apparatus.
   (7)

The information processing apparatus according to (5),
in which the processor is configured to perform, in a case where the input of the disposition change data is received from the user, control of switching between a state in which an operation image for giving an instruction to perform the disposition change of the virtual projection surface is displayed on a display device and a state in which an operation image for giving an instruction to perform the disposition change of the virtual projection apparatus is displayed on the display device.
   (8)

The information processing apparatus according to (5),
in which the processor is configured to perform at least any one of control of changing the disposition of the virtual projection surface according to an operation performed by the user on the virtual projection surface in the second image displayed on a display device, or control of changing the disposition of the virtual projection apparatus according to an operation performed by the user on the virtual projection apparatus in the second image displayed on the display device.
   (9)

The information processing apparatus according to any one of (1) to (8),
in which the processor is configured to maintain, in a case where a position of the virtual projection apparatus is changed based on the disposition change data, a position of the virtual projection surface.
   (10)

The information processing apparatus according to (9),
in which the processor is configured to maintain, in a case where the position of the virtual projection apparatus is changed in a direction different from a lens optical axis direction of the virtual projection apparatus, the position of the virtual projection surface by changing a parameter of a shift of a projection position of the virtual projection apparatus.
   (11)

The information processing apparatus according to (9) or (10),
in which the processor is configured to change, in a case where the position of the virtual projection apparatus is changed in a lens optical axis direction of the virtual projection apparatus, a size of the virtual projection surface.
   (12)

The information processing apparatus according to any one of (1) to (11),
in which the processor is configured to rotate, in a case where the virtual projection apparatus is rotated about an axis in a lens optical axis direction of the virtual projection apparatus based on the disposition change data, the virtual projection surface in accordance with the rotation of the virtual projection apparatus.
   (13)

The information processing apparatus according to any one of (1) to (12),
in which the processor is configured to maintain, in a case where a position of the virtual projection surface is changed based on the disposition change data, a position of the virtual projection apparatus.
   (14)

The information processing apparatus according to any one of (1) to (13),
in which the processor is configured to rotate, in a case where the virtual projection surface is rotated about an axis in a direction orthogonal to the virtual projection surface based on the disposition change data, the virtual projection apparatus in accordance with the rotation of the virtual projection surface.
   (15)

The information processing apparatus according to any one of (1) to (14),
in which the second image is an image displaying an installable range in which the virtual projection apparatus is installable.
   (16)

The information processing apparatus according to (15),
in which the processor is configured to change, in a case where a position of the virtual projection surface is changed based on the disposition change data, a position of the installable range in accordance with the change in the position of the virtual projection surface.
   (17)

The information processing apparatus according to (15) or (16),
in which the processor is configured to rotate, in a case where the virtual projection surface is rotated based on the disposition change data, the installable range in accordance with the rotation of the virtual projection surface.
   (18)

The information processing apparatus according to any one of (15) to (17),
in which the processor is configured to change, in a case where a size of the virtual projection surface is changed based on the disposition change data, a position and/or a size of the installable range in accordance with the change in the size of the virtual projection surface.
   (19)

The information processing apparatus according to any one of (15) to (18),
in which the processor is configured to change, in a case where a position of the virtual projection apparatus is changed based on the disposition change data, the position of the virtual projection apparatus within the installable range.
   (20)

The information processing apparatus according to any one of (1) to (19),
in which an image displayed on the virtual projection surface included in the second image is an image selected by a user.
   (21)

The information processing apparatus according to (20),
in which the processor is configured to perform at least any one of rotation, enlargement, or reduction of the image of the virtual projection surface according to an operation from the user.
   (22)

The information processing apparatus according to any one of (1) to (21),
in which the processor is configured to change an aspect ratio of the virtual projection surface according to an operation from the user.
   (23)

The information processing apparatus according to (22),
in which the processor is configured to change a length of a diagonal line of the virtual projection surface in association with the change in the aspect ratio.
   (24)

The information processing apparatus according to (22),
in which the processor is configured to change a distance between the virtual projection surface and the virtual projection apparatus in association with the change in the aspect ratio.
   (25)

The information processing apparatus according to any one of (1) to (24),
in which the processor is configured to:
   extract installation postures among installation posture candidates of the virtual projection apparatus based on an installation position of the virtual projection apparatus in the space; and
   reflect the installation posture of the virtual projection apparatus selected from among the extracted installation postures in the second image.
      (26)

The information processing apparatus according to any one of (1) to (25),
in which the processor is configured to perform control of switching between a state in which a shift range in which a shift of a projection position of the virtual projection apparatus is possible is displayed on the second image and a state in which the shift range is not displayed on the second image.
   (27)

The information processing apparatus according to any one of (1) to (26),
in which the processor is configured to perform control of displaying, on a display device, a projection parameter of the virtual projection apparatus corresponding to the disposition of the virtual projection surface and the virtual projection apparatus represented by the second image.
   (28)

The information processing apparatus according to any one of (1) to (27),
in which the processor is configured to perform, in a case where a plurality of combinations of the virtual projection surface and the virtual projection apparatus are present, control of setting a combination selected from among the plurality of combinations by a user operation as a disposition change target.
   (29)

The information processing apparatus according to any one of (1) to (28),
in which the second image is an image representing a boundary of projection light from the virtual projection apparatus to the virtual projection surface.
   (30)

The information processing apparatus according to any one of (1) to (29),
in which the disposition change data includes data for giving an instruction to change a position of the virtual projection apparatus, and a first projection center of the virtual projection apparatus in the virtual projection surface due to a shift of a projection position of the virtual projection apparatus, and
the processor is configured to:
   set a second projection center of the virtual projection apparatus in the virtual projection surface in a case where the shift of the projection position is not performed, based on the disposition change data; and
   change a size of the virtual projection surface based on the second projection center.
      (31)

The information processing apparatus according to (30),
in which the processor is configured to change a direction of the position of the virtual projection apparatus such that the position is directed toward the second projection center.
   (32)

An information processing method using an information processing apparatus,
in which a processor of the information processing apparatus is configured to:
   acquire first image data representing a first image obtained by imaging with an imaging device;
   acquire disposition data related to a disposition of a virtual projection surface and a virtual projection apparatus in a space indicated by the first image;
   acquire disposition change data related to a disposition change of the virtual projection surface and/or the virtual projection apparatus in the first image;
   generate second image data representing a second image in which the virtual projection surface and/or the virtual projection apparatus of which the disposition is changed based on the disposition change data is displayed on the first image; and
   output the second image data to an output destination.
      (33)

An information processing program of an information processing apparatus, the information processing program causing a processor of the information processing apparatus to execute a process comprising:
acquiring first image data representing a first image obtained by imaging with an imaging device;
acquiring disposition data related to a disposition of a virtual projection surface and a virtual projection apparatus in a space indicated by the first image;
acquiring disposition change data related to a disposition change of the virtual projection surface and/or the virtual projection apparatus in the first image;
generating second image data representing a second image in which the virtual projection surface and/or the virtual projection apparatus of which the disposition is changed based on the disposition change data is displayed on the first image; and
outputting the second image data to an output destination.

Although various embodiments have been described above, it is needless to say that the present invention is not limited to such examples. It is apparent that those skilled in the art may perceive various modification examples or correction examples within the scope disclosed in the claims, and those examples are also understood as falling within the technical scope of the present invention. In addition, each constituent in the embodiment may be used in any combination without departing from the gist of the invention.

The present application is based on Japanese Patent Application (JP2021-214489A) filed on Dec. 28, 2021, the content of which is incorporated in the present application by reference.

### EXPLANATION OF REFERENCES

1: projection portion
2: operation reception portion
4: control device
4a, 62: memory
2a, 2b, 3a, 3c, 15a: opening
2A, 3A: hollow portion
6: projection object
10: projection apparatus
11: projection range
12: optical modulation unit
15: housing
21: light source
22: optical modulation portion
23: projection optical system
24: control circuit
31: second optical system
32, 122: reflective member
33: third optical system
34: lens
50: information processing apparatus
51: touch panel
61: processor
63: communication interface
64: user interface
65: sensor
69: bus
70: space image
101: body part
102: first member
103: second member
104: projection direction changing mechanism
105: shift mechanism
106: optical unit
121: first optical system
201: projection apparatus installation virtual surface
202: virtual projection apparatus
203: projection surface installation virtual surface
204: virtual projection surface
A1: virtual projection apparatus operation region
A2: virtual projection surface operation region
B11: operation target switching button
B12: posture change button
B13: rotation button
B14: up/down movement button
B15: front/rear/left/right movement button
B21: aspect ratio change button
B22: image setting button
B23: image rotation button
B24: projection surface rotation button
B25: up/down/left/right movement button
B31: size change lock release button
B32: horizontal movement lock release button
B33: rotation lock release button
d1: projection distance
D1, D3, D4: distance
F1: shift range
F2: installable range
G1: image
P1: lens center point
P2 to P4: projection center point
UI1 to UI4: operation image

What is claimed is:

1. An information processing apparatus comprising a processor,
wherein the processor is configured to:
acquire first image data representing a first image obtained by imaging with an imaging device;
acquire disposition data related to a disposition of a virtual projection surface and a virtual projection apparatus in a space indicated by the first image;
acquire disposition change data including data for giving an instruction to change a position of the virtual projection apparatus and a first projection center of the virtual projection apparatus in the virtual projection surface due to a shift of a projection position of the virtual projection apparatus;
set a second projection center of the virtual projection apparatus in the virtual projection surface in a case where the shift of the projection position is not performed, based on the disposition change data;
change a size of the virtual projection surface based on the second projection center;
generate second image data representing a second image in which at least one of the virtual projection surface or the virtual projection apparatus of which the disposition is changed based on the disposition change data is displayed on the first image; and
output the second image data to an output destination.

2. The information processing apparatus according to claim 1, further comprising:
a display device,
wherein the output destination is the display device.

3. The information processing apparatus according to claim 1, further comprising:
the imaging device.

4. The information processing apparatus according to claim 1, further comprising:
an input receiver that receives input of the disposition change data from a user.

5. The information processing apparatus according to claim 4,
wherein the processor is configured to perform, in a case where the input of the disposition change data is received from the user, control of displaying, on a display device, an image including an operation image for giving an instruction to perform the disposition change of the virtual projection surface and an operation image for giving an instruction to perform the disposition change of the virtual projection apparatus.

6. The information processing apparatus according to claim 4,
wherein the processor is configured to perform, in a case where the input of the disposition change data is received from the user, control of switching between a state in which an operation image for giving an instruction to perform the disposition change of the virtual projection surface is displayed on a display device and a state in which an operation image for giving an instruction to perform the disposition change of the virtual projection apparatus is displayed on the display device.

7. The information processing apparatus according to claim 4,
wherein the processor is configured to perform at least one of: control of changing the disposition of the virtual projection surface according to an operation performed by the user on the virtual projection surface in the second image displayed on a display device; or control of changing the disposition of the virtual projection apparatus according to an operation performed by the user on the virtual projection apparatus in the second image displayed on the display device.

8. The information processing apparatus according to claim 1,
wherein the processor is configured to maintain, in a case where a position of the virtual projection apparatus is changed based on the disposition change data, a position of the virtual projection surface.

9. The information processing apparatus according to claim 8,
wherein the processor is configured to maintain, in a case where the position of the virtual projection apparatus is changed in a direction different from a lens optical axis direction of the virtual projection apparatus, the position of the virtual projection surface by changing a parameter of a shift of a projection position of the virtual projection apparatus.

10. The information processing apparatus according to claim 8,
wherein the processor is configured to change, in a case where the position of the virtual projection apparatus is changed in a lens optical axis direction of the virtual projection apparatus, a size of the virtual projection surface.

11. The information processing apparatus according to claim 1,
wherein the processor is configured to rotate, in a case where the virtual projection apparatus is rotated about an axis in a lens optical axis direction of the virtual projection apparatus based on the disposition change data, the virtual projection surface in accordance with the rotation of the virtual projection apparatus.

12. The information processing apparatus according to claim 1,
wherein the processor is configured to maintain, in a case where a position of the virtual projection surface is changed based on the disposition change data, a position of the virtual projection apparatus.

13. The information processing apparatus according to claim 1,
wherein the processor is configured to rotate, in a case where the virtual projection surface is rotated about an axis in a direction orthogonal to the virtual projection surface based on the disposition change data, the virtual projection apparatus in accordance with the rotation of the virtual projection surface.

14. The information processing apparatus according to claim 1,
wherein the second image is an image displaying an installable range in which the virtual projection apparatus is installable.

15. The information processing apparatus according to claim 14,
wherein the processor is configured to change, in a case where a position of the virtual projection surface is changed based on the disposition change data, a position of the installable range in accordance with the change in the position of the virtual projection surface.

16. The information processing apparatus according to claim 14,
wherein the processor is configured to rotate, in a case where the virtual projection surface is rotated based on the disposition change data, the installable range in accordance with the rotation of the virtual projection surface.

17. The information processing apparatus according to claim 14,
wherein the processor is configured to change, in a case where a size of the virtual projection surface is changed based on the disposition change data, at least one of a position or a size of the installable range in accordance with the change in the size of the virtual projection surface.

18. The information processing apparatus according to claim 14,
wherein the processor is configured to change, in a case where a position of the virtual projection apparatus is changed based on the disposition change data, the position of the virtual projection apparatus within the installable range.

19. The information processing apparatus according to claim 1,
wherein an image displayed on the virtual projection surface included in the second image is an image selected by a user.

20. The information processing apparatus according to claim 19,
wherein the processor is configured to perform at least one of rotation, enlargement, or reduction of the image of the virtual projection surface according to an operation from the user.

21. The information processing apparatus according to claim 1,
wherein the processor is configured to change an aspect ratio of the virtual projection surface according to an operation from the user.

22. The information processing apparatus according to claim 21,
wherein the processor is configured to change a length of a diagonal line of the virtual projection surface in association with the change in the aspect ratio.

23. The information processing apparatus according to claim 21,
wherein the processor is configured to change a distance between the virtual projection surface and the virtual projection apparatus in association with the change in the aspect ratio.

24. The information processing apparatus according to claim 1,
wherein the processor is configured to:
extract installation postures among installation posture candidates of the virtual projection apparatus based on an installation position of the virtual projection apparatus in the space; and
reflect, in the second image, the installation posture of the virtual projection apparatus selected from among the extracted installation postures.

25. The information processing apparatus according to claim 1,
wherein the processor is configured to be capable of performing control of switching between a state in which a shift range in which a shift of a projection position of the virtual projection apparatus is possible is displayed on the second image and a state in which the shift range is not displayed on the second image.

26. The information processing apparatus according to claim 1,
wherein the processor is configured to perform control of displaying, on a display device, a projection parameter of the virtual projection apparatus corresponding to the disposition of the virtual projection surface and the virtual projection apparatus represented by the second image.

27. The information processing apparatus according to claim 1,
wherein the processor is configured to perform, in a case where a plurality of combinations of the virtual projection surface and the virtual projection apparatus are present, control of setting a combination selected from among the plurality of combinations by a user operation as a disposition change target.

28. The information processing apparatus according to claim 1,
wherein the second image is an image representing a boundary of projection light from the virtual projection apparatus to the virtual projection surface.

29. The information processing apparatus according to claim 1,
wherein the processor is configured to change a direction of the position of the virtual projection apparatus so as to be directed toward the second projection center.

30. An information processing method performed by a processor of an information processing apparatus, the method comprising:
acquiring first image data representing a first image obtained by imaging with an imaging device;
acquiring disposition data related to a disposition of a virtual projection surface and a virtual projection apparatus in a space indicated by the first image;
acquiring disposition change data including data for giving an instruction to change a position of the virtual projection apparatus and a first projection center of the virtual projection apparatus in the virtual projection surface due to a shift of a projection position of the virtual projection apparatus;
setting a second projection center of the virtual projection apparatus in the virtual projection surface in a case where the shift of the projection position is not performed, based on the disposition change data;
changing a size of the virtual projection surface based on the second projection center;
generating second image data representing a second image in which at least one of the virtual projection surface or the virtual projection apparatus of which the disposition is changed based on the disposition change data is displayed on the first image; and
outputting the second image data to an output destination.

31. A non-transitory computer readable medium storing an information processing program, the information processing program causing a processor of an information processing apparatus to execute a process comprising:
acquiring first image data representing a first image obtained by imaging with an imaging device;
acquiring disposition data related to a disposition of a virtual projection surface and a virtual projection apparatus in a space indicated by the first image;
acquiring disposition change data including data for giving an instruction to change a position of the virtual projection apparatus and a first projection center of the virtual projection apparatus in the virtual projection surface due to a shift of a projection position of the virtual projection apparatus;
setting a second projection center of the virtual projection apparatus in the virtual projection surface in a case where the shift of the projection position is not performed, based on the disposition change data;
changing a size of the virtual projection surface based on the second projection center;
generating second image data representing a second image in which at least one of the virtual projection surface or the virtual projection apparatus of which the disposition is changed based on the disposition change data is displayed on the first image; and
outputting the second image data to an output destination.
